(19) United States
(12) Patent Application Publication
(10) Pub. No.: US 2024/0000105 A1
(43) Pub. Date: Jan. 4, 2024

(54) JACKFRUIT BASED MEAT REPLACEMENTS

(71) Applicant: GLOBAL VILLAGE FRUIT, INC., Boulder, CO (US)

(72) Inventors: Annemarie RYU, Boulder, CO (US); Larry EISENBERG, Boulder, CO (US); Gregory BAIR-CARUSO, Boulder, CO (US); Marc BLITZSTEIN, Boulder, CO (US); Kenneth JENNER, Boulder, CO (US)

(73) Assignee: GLOBAL VILLAGE FRUIT, INC., Boulder, CO (US)

(21) Appl. No.: 18/254,137

(22) PCT Filed: Jun. 2, 2021
(86) PCT No.: PCT/US2021/035523

§ 371 Date: May 23, 2023

Related U.S. Application Data
(60) Provisional application No. 63/117,939, filed on Nov. 24, 2020.
(60) Provisional application No. 63/153,986, filed on Feb. 26, 2021.

(51) Int. Cl. A23J 3/22; A23L 19/00; A23J 3/16; A23J 3/04

(52) U.S. Cl. CPC A23J 3/227; A23L 19/09; A23J 3/16; A23J 3/04

(57) ABSTRACT

Disclosed herein are meat-like food products, or compositions used to prepare meat-like food products, comprising jackfruit or a jackfruit derivative. Also disclosed herein are meat-like food products, or compositions used to prepare meat-like food products, comprising jackfruit or a jackfruit derivative as a main component. Further disclosed herein are meat-like food products, or compositions used to prepare meat-like food products, having desirable textural, mouth feel, and/or appearance characteristics. Methods of preparing the meat-like food products, or compositions used to prepare meat-like food products, are also disclosed herein.

### CROSS-REFERENCE TO RELATED APPLICATIONS

This application claims the benefit of and priority to U.S. Provisional Patent Application No. 63/117,939, filed Nov. 24, 2020, and U.S. Provisional Patent Application No. 63/153,986, filed Feb. 26, 2021, each of which is hereby incorporated by reference in its entirety.

### BACKGROUND OF INVENTION

Foods considered as plant-based meat alternatives have exploded in popularity due to their many environmental and health benefits. Jackfruit is particularly powerful as a base ingredient in meat alternatives because of its nutritional benefits compared to meat. Jackfruit also has a sinewous, striated nature that facilitates its use in an extremely wide variety of meat alternatives, including replacements to beef, chicken, pork, seafood, in either cooked or raw form.

Jackfruit has very high fiber content, which is one reason why it has such a sturdy, meat-like, striated, sinewous texture. In contrast, meat has little to no fiber, and those eating a diet high in meat are typically heavily deficient in fiber. Jackfruit is also low in calories, free of saturated fat, and free of cholesterol. Consequently, certain finished products that use jackfruit as a major ingredient are capable of resulting in foods that have a pleasing texture and are significantly lower in total fat and saturated fat, and higher in fiber, as compared to the parallel products made from meat. Because jackfruit is higher in fiber and lower in calories, compared to parallel meat products, products containing a significant amount of jackfruit are uniquely filling or satiating relative to their caloric value.

Despite the many benefits of decreasing consumption of meat and increasing consumption of plant-based meat alternatives, some are reluctant to do so. Such reluctance can result from a lack of available plant-based meat alternative food choices on the market with desirable characteristics, such as desired texture, flavor, and nutrition.

As a result, a need exists for plant-based meat alternatives that have desirable characteristics. The invention disclosed herein is directed to these, as well as other, goals.

### SUMMARY OF THE INVENTION

Disclosed herein is a meat-like food product, comprising jackfruit or a jackfruit derivative in an amount of at least about 10 wt. %.

Disclosed herein is a method of preparing a meat-like food product, or the composition used to prepare a meat-like food product, the method comprising providing jackfruit pieces, mixing the jackfruit pieces with a binding agent, a protein additive, and water to form a mixture, and forming, sheeting, or extruding the mixture into a desired shape, wherein the desired shape is the meat-like food product or the composition used to prepare the meat-like food product.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1: Size-reduced jackfruit prepared as described in Example 4 (scale bar is approximately 1 inch).

FIG. 2: Size-reduced jackfruit prepared as described in Example 4 (scale bar is approximately 1 inch).

FIG. 3: Size-reduced jackfruit prepared as described in Example 4 (scale bar is approximately 1 inch).

### STATEMENTS REGARDING CHEMICAL COMPOUNDS AND NOMENCLATURE

In general, the terms and phrases used herein have their art-recognized meaning, which can be found by reference to standard texts, journal references and contexts known to those skilled in the art. The following definitions are provided to clarify their specific use in the context of the invention.

The term “meat-like” refers to a food product having a mouth-feel and texture reminiscent of meat, especially when considered from the perspective of a person familiar with eating plant-based meat alternative food products.

The term “jackfruit or jackfruit derivative” refers to a component that is jackfruit flesh (cooked or raw), or such term refers to a component that is prepared from jackfruit (cooked or raw). For example, jackfruit or a jackfruit derivative can include jackfruit that is processed in a way that facilitates its incorporation into a meat-like product as disclosed herein. In some aspects, for example, the jackfruit or jackfruit derivative comprises jackfruit flour, jackfruit extract, canned jackfruit, or cooked jackfruit, or any combination thereof. In some aspects, the jackfruit or jackfruit derivative comprises jackfruit pieces or size-reduced pieces prepared in a manner as described elsewhere herein, or any combination thereof. For example, the jackfruit or jackfruit derivative is prepared, in some aspects, by a process comprising one or more of washing, peeling, immersion in a solution, size reduction, cooking, cooling, freezing, grinding, or any combination thereof, as described elsewhere herein.

The term “young jackfruit” refers to a jackfruit that is harvested at an early developmental stage and has the particular parameters specified elsewhere herein. For example, a young jackfruit has one or more of a particular spine density, mass, age when harvested as measured from the date of flower setting on the trees, and a specified content of sugar that is typically digestible by humans or is free or substantially free of sugars typically digestible by humans.

As used herein, “cell-based meat” means meat grown from undifferentiated cells or partially differentiated cells and is also known in the food industry as lab-grown meat, cultured meat, or clean meat.

As used herein, the term “a composition used to prepare the meat-like food product” refers to a composition that results from mixing known amounts of individual ingredients. In some aspects, such a composition is then typically cooked or otherwise treated, as disclosed elsewhere herein, to prepare the meat-like food product.

The terms “a meat-like food product” and “a composition used to prepare the meat-like food product” are used herein. In some aspects, these two terms refer to different compositions, for example, where a composition is prepared as disclosed herein, and then such a composition is treated (e.g., via cooking or heating), which treatment removes some of the water content or otherwise changes the final composition of the meat-like food product relative to the starting composition (in terms of component amounts). In other aspects, these two terms are synonymous, for example, where a composition is prepared as disclosed herein, formed into a desired shape, and then treated (e.g., via cooking or heating), which treatment does not change, or does not substantially change, the final composition of the meat-like food product relative to the starting composition (in terms of component amounts).

As used herein, the terms “integrally incorporated” or “integral incorporation” in reference to jackfruit or a jackfruit derivative means that the jackfruit or jackfruit derivative is uniformly dispersed throughout the meat-like food product or composition used to prepare the meat-like food product. Such uniform dispersion of jackfruit in some aspects results in a meat-like food product having meat-like attributes, such as texture and mouth feel, that are continuous throughout the meat-like food product. The relatively small size of jackfruit or jackfruit derivative pieces (e.g., certain sizes and/or masses disclosed elsewhere herein) relative to the size of the meat-like food product and the perception capabilities of a human when biting and/or chewing the meat-like food product results, in some aspects, in meat-like attributes, such as texture and mouth feel. Such integral incorporation within a meat-like food product or composition used to prepare the meat-like food product can, in some aspects, take the form of a matrix comprising size-reduced jackfruit or jackfruit derivative dispersed uniformly therein (e.g., in some aspects, the matrix also comprises protein additive, binding agent, oil, or any combination thereof). In some aspects, the matrix is a solid or semi-solid structure in which the components of the matrix substantially maintain their relative location and orientation to the other components of the matrix in three-dimensional space. Such integral incorporation of jackfruit is to be contrasted with, for example, a food product having larger chunks of jackfruit (e.g., 2 cm cubes) present in a sauce (e.g., curry sauce, barbecue sauce, or other sauce). Although at a certain scale even 1 nm cubes might be considered “chunks,” the scale relevant herein is the human scale of taste and perception. In such a food product with larger chunks of jackfruit, the jackfruit is not uniformly dispersed throughout the food product, since large gaps exist between jackfruit chunks (e.g., separated by sauce), and the food product therefore does not have meat-like attributes that are continuous throughout the food product. Such integral incorporation of jackfruit is also to be contrasted with whole jackfruit or chunks of jackfruit alone. In some aspects, the meat-like food product is in the form of a single piece that may be rigid or semi-rigid, which is to be contrasted, for example, with chunks of jackfruit in a sauce. In some aspects, uniform dispersion of jackfruit or a jackfruit derivative can be accomplished using the methods disclosed herein, for example, such as shredding, grinding, or otherwise size-reducing the jackfruit or jackfruit derivative to a desired size, uniformly mixing such size-reduced jackfruit with other ingredients (such as a protein additive, a binding agent, oil, flavor, water, or any combination thereof), and then extruding, sheeting, or otherwise forming such a composition into a desired shape, optionally followed by further processing (e.g., cooking or heating).

In an aspect, a composition or product disclosed herein can be “substantially free” of a given component. Typically, the meaning of “substantially free” will be clear from context to one of ordinary skill in the art. For example, when a food composition or food product is “substantially free” of an allergen, generally standards in the food industry dictate the meaning of “substantially free.” However, for clarity, if a meaning for “substantially free” cannot be discerned from industry standards, then “substantially free,” as used herein, means the composition or product at issue will have no more than about 1%, preferably less than about 0.5%, more preferably less than about 0.1% by weight of the relevant component, based on the total weight of the composition or product at issue containing the relevant component.

In an aspect, a composition or compound of the invention, such as an additive, is isolated or substantially purified. In an aspect, an isolated or purified compound is at least partially isolated or substantially purified as would be understood in the art. In an aspect, a substantially purified composition, compound or formulation of the invention has a chemical purity of 95%, optionally for some applications 99%, optionally for some applications 99.9%, optionally for some applications 99.99%, and optionally for some applications 99.999% pure.

Unless otherwise specified, all weight percent values herein are based on 100 wt. % of the meat-like food product, or the composition used to prepare the meat-like food product, as will be clear from context. If such weight percent values are not clear from context, then such values refer to 100 wt. % of the composition used to prepare the meat-like food product. In addition, unless specified otherwise, all weight percent values of components (e.g., jackfruit or a jackfruit derivative, protein additive, binding agent, water, at least one additional ingredient) refer to the amount of added component, rather than to amounts of any component that may also be present from other sources. In this regard, for example, unless otherwise specified, a water amount refers to the amount of water that has been added, rather than to the amount of water that may also be present from other sources, such as the water naturally present in jackfruit.

### DETAILED DESCRIPTION OF THE INVENTION

In the following description, numerous specific details of the devices, device components and methods of the present invention are set forth in order to provide a thorough explanation of the precise nature of the invention. It will be apparent, however, to those of skill in the art that the invention can be practiced without these specific details.

As used herein, the term “about” means that slight variations from a stated value may be used to achieve substantially the same results as the stated value. Also, the disclosure of ranges is intended as a continuous range including every value between the minimum and maximum values recited as well as any ranges that may be formed by such values. Also disclosed herein are any and all ratios (and ranges of any such ratios) that may be formed by dividing a recited numeric value into any other recited numeric value. Accordingly, the skilled person will appreciate that many such ratios, ranges, and ranges of ratios may be unambiguously derived from the numerical values presented herein and in all instances such ratios, ranges, and ranges of ratios represent various embodiments of the present invention.

When disclosing numerical values herein, for example, 1, 2, 3, 4, 5, 6, 7, 8, 9, 10, the following sentence typically follows such numerical values: “Each of the foregoing numbers can be preceded by the term ‘about,’ ‘at least about,’ or ‘less than about,’ and any of the foregoing numbers can be used singly to describe an open-ended range or in combination to describe a close-ended range.” This sentence means that each of the aforementioned numbers can be used alone (e.g., 4), can be prefaced with the word “about” (e.g., about 8), prefaced with the phrase “at least about” (e.g., at least about 2), prefaced with the phrase “less than about” (e.g., less than about 7), or used in any combination with or without any of the prefatory words or phrases to define a range (e.g., 2 to 9, about 1 to 4, 8 to about 9, about 1 to about 10, and so on). Moreover, when a range is described as “about X or less,” this phrase is the same as a range that is a combination of “about X” and “less than about X” in the alternative. For example, “about 10 or less” is the same as “about 10, or less than about 10.” Such interchangeable range descriptions are contemplated herein. Other range formats are disclosed herein, but the difference in formats should not be construed to imply that there is a difference in substance.

A wide array of plant-based meat alternatives (for example, from burgers and dinner sausages to nuggets and pulled pork) has been developed in which jackfruit, in some aspects, is a main ingredient, and contributes substantially to the textural structure, mouth feel, and appearance. Jackfruit is typically harvested at a stage of maturation where its internal texture/structure is maximally meat-like. In some aspects, this “young” jackfruit is combined with other ingredients (as detailed below) to deliver meat-like texture, flavor, and appearance. In some aspects, the meat-like texture of the meat-like food product is unexpectedly derived significantly or substantially from jackfruit. In this regard, in some aspects, the fibers in jackfruit are naturally aligned, and such natural alignment contributes to the meat-like texture of the meat-like food products disclosed herein. As described elsewhere, in some aspects the fibers within the jackfruit radiate outward from the central axis and such alignment contributes to the meat-like texture of the meat-like food products disclosed herein. In some aspects, the meat-like food product, or the composition used to prepare the meat-like food product, comprises jackfruit or jackfruit derivative, in which the jackfruit or jackfruit derivative comprises naturally aligned fibers. In some aspects, the meat-like texture of the meat-like food product is unexpectedly derived significantly or substantially from the combination of jackfruit and a binding agent (e.g., the cooperative combination of jackfruit and a binding agent). In some aspects, the meat-like texture of the meat-like food product is unexpectedly derived significantly or substantially from the combination of jackfruit and a protein additive (e.g., the cooperative combination of jackfruit and a protein additive). In some aspects, the meat-like texture of the meat-like food product is unexpectedly derived significantly or substantially from the combination of jackfruit, a binding agent, and a protein additive (e.g., the cooperative combination of jackfruit, a binding agent, and a protein additive). In some aspects, the meat-like texture of the meat-like food product is unexpectedly derived significantly or substantially from the combination of jackfruit, a binding agent, and oil (e.g., the cooperative combination of jackfruit, a binding agent, and oil). In some aspects, the meat-like texture of the meat-like food product is unexpectedly derived significantly or substantially from the combination of jackfruit, a protein additive, and oil (e.g., the cooperative combination of jackfruit, a protein additive, and oil). In some aspects, the meat-like texture of the meat-like food product is unexpectedly derived significantly or substantially from the combination of jackfruit, a binding agent, a protein additive, and oil (e.g., the cooperative combination of jackfruit, a binding agent, a protein additive, and oil). In some aspects, the protein additive comprises protein from a non-animal source, an animal source, or a combination thereof. In some aspects, the meat-like food product, or the composition used to prepare the meat-like food product, contains less texturizing agent than other plant-based meat alternatives, for example, as a result of replacing such texturizing agent with jackfruit or a jackfruit derivative while still achieving desirable texture and/or appearance in the meat-like food product. In some aspects, the relatively small size of jackfruit or jackfruit derivative pieces (e.g., certain sizes and/or masses disclosed elsewhere herein) relative to the size of the meat-like food product and the perception capabilities of a human when biting and/or chewing the meat-like food product unexpectedly results in meat-like attributes, such as texture, mouth feel, and appearance.

As compared to competitive plant-based offerings, the meat-like products disclosed herein typically have desirable meat-like characteristics while being less processed than competitive products. In some aspects, the main ingredient by weight is jackfruit, instead of water. In some aspects, the second-largest component by weight is water, for example, in some aspects the jackfruit or jackfruit derivative is present in an amount higher than the amount of water, based on the total weight of the meat-like food product or the total weight of the composition used to prepare the meat-like food product. In some aspects, the third-largest component is a protein additive (e.g., a protein isolate or protein additive), for example, the jackfruit or jackfruit derivative is present in an amount higher than the amount of protein additive and/or water, and in some aspects the water is present in an amount higher than the amount of protein additive, based on the total weight of the meat-like food product or the total weight of the composition used to prepare the meat-like food product. In some aspects, jackfruit's texture provides a structural foundation for the meat-like food products disclosed herein. In contrast, competitive plant-based meat alternative products are heavily processed to achieve a meat-like structure using water and powder, and include more functional ingredients, in order to achieve a similar kind of textural or structural foundation. It is worth noting that the isolates or additives used historically in plant-based meat alternatives are, in some aspects, top-8 allergens (e.g., soy and gluten), and have a very high risk of being genetically modified, whereas jackfruit typically is not a major allergen and generally has not been genetically modified. Even in aspects where a meat-like food product includes an allergen, the allergen typically is present in an amount less than in a comparable plant-based meat alternative product that does not contain jackfruit, providing a product that is less allergenic to susceptible individuals.

Jackfruit is particularly powerful as a base ingredient in meat alternatives because of its nutritional benefits as compared to meat. Jackfruit has very high fiber content, which is one reason why it has such a sturdy, meat-like, striated, sinewous texture. In contrast, meat has little to no fiber, and those eating a diet high in meat are typically heavily deficient in fiber. Jackfruit is also naturally substantially free of any fats, low in calories, free of saturated fat, and free of cholesterol. Consequently, certain finished products that use jackfruit as a major ingredient are capable of resulting in foods that have a pleasing texture and are significantly lower in total fat, saturated fat, and cholesterol, and higher in fiber, as compared to the parallel products made from meat. In addition, the fiber in jackfruit contributes to jackfruit's robustness and resistance to degradation: jackfruit can be frozen and thawed, with minimal change to its texture, textural strength, and/or integrity. Furthermore, jackfruit can be broken down into small pieces or even ground into fine pieces, and in these forms, continue to contribute textural firmness, strength, and/or structure. Jackfruit also has a neutral flavor, and readily absorbs the flavors of sauces, seasonings and other ingredients, especially with the application of heat and mixing. In some aspects, jackfruit's fiber is part of what enables it to easily take up and hold onto flavors, such as with marinades. Thus, jackfruit is an extremely versatile ingredient/food, capable of lending itself to mimic a very wide range of meats.

Regarding jackfruit's high fiber content, it is recommended that people eat about 25-30 grams of fiber per day, which amount should include about 6-8 grams of soluble fiber. In 100 grams of young jackfruit, there is about 5-10 grams of dietary fiber (15-40% RDV) and about 1-3 grams of soluble fiber (10-50% RDV) (RDV=recommended daily value).

Jackfruit is nutritious, contributing a variety of nutrients, minerals, and vitamins to food products (e.g., meat-like food products) prepared with jackfruit. Examples of such nutrients, minerals, and vitamins include protein, magnesium, manganese, potassium, iron, zinc, copper, vitamin E, vitamin A, or any combination thereof.

The use of jackfruit as a substrate means that the meat-like products disclosed herein can be made in some cases with commercially available food processing and meat processing equipment. Certain adaptations to equipment may be desired, or the equipment operated differently, but, in some aspects, an entirely new type of equipment does not necessarily need to be created in order to make a wide variety of meat alternatives that use jackfruit as the base.

Jackfruit's sinewy nature easily enables an extremely wide variety of meat-like products to be prepared: replacements to beef, chicken, pork, seafood—cooked or raw. In one aspect, the target meat-like product with desired properties can be prepared by selecting harvesting parameters, a piece of equipment, processing conditions, and additional ingredients. In addition, different parts of the jackfruit—the core vs the flesh, for example—have different textures. The fibers within the jackfruit radiate outward from the central axis. Consequently, in some aspects, the way that the fruit is cut, such as being sliced, shredded, chopped, de-cored etc., and the part of the fruit that is used—a part with denser fibers, for example—lends the fruit to more closely mimic one type of meat vs another (pulled chicken vs whole-muscle seafood, for example). Different fruit temperatures impact the results, as does the angle at which a fruit is added into machinery, as does the type of fruit cut used as the ingredient into the product recipe or process. For example, the angle at which the jackfruit is added to the machinery (e.g., dicing, slicing, cutting, grinding, etc.) results in different sized and shaped pieces of the resulting size-reduced jackfruit. This angle is defined as the angle between the long axis of the jackfruit and a theoretical horizontal plane (i.e., the plane that the jackfruit approaches as the jackfruit moves towards the machinery's size-reducing mechanism by way of an applied force in any direction or gravity). This angle (degrees), with 90 representing the long axis of the jackfruit perpendicular to the horizontal plane, can be 0, 5, 10, 15, 20, 25, 30, 35, 40, 45, 50, 55, 60, 65, 70, 75, 80, 85, or 90. Each of the foregoing numbers can be preceded by the word “about,” “at least about,” or “less than about,” and any of the foregoing numbers can be used singly to describe an open-ended range or in combination to describe a close-ended range. For example, in some aspects, the angle (degrees) is about 40 to about 55, about 90, about 0, or about 15 to about 40. Moreover, the temperature (° C.) at which the jackfruit is cut is −30, −25, −20, −15, −10, −5, 0, 5, 10, 15, 20, 25, 30, 35, 40, 45, or 50. Each of the foregoing numbers can be preceded by the word “about,” “at least about,” or “less than about,” and any of the foregoing numbers can be used singly to describe an open-ended range or in combination to describe a close-ended range. For example, in some aspects, the temperature (° C.) is −10 to about 0, about −5 to about 20, or 5 to 15.

In some aspects, the jackfruit or jackfruit derivative is integrally incorporated into the meat-like food product or composition used to prepare the meat-like food product.

In some aspects, the jackfruit or jackfruit derivative employed herein is harvested before ripening, for example, at a stage of maturation before substantially any sugars develop and when the internal texture is most similar to traditional meat. This type of jackfruit is a “young jackfruit” as further disclosed elsewhere herein. In some aspects, the jackfruit is processed in the following way: Washed/cleaned, peeled, cubed/cut/shredded (based on which jackfruit input cut/shape delivers the best finished product), blanched, and individually quick-frozen; Ground/processed at a specific temperature using meat-processing equipment such as meat grinders with various different types of grinding plates and one or more grinding steps; Mixed with seasonings, vegetable protein(s) (various possible), natural flavors, natural colors, oils, plant fiber, and/or binders (various possible); and Formed and cooked using processes similar to corresponding meat products.

In some aspects, the meat-like food product has a meat-like texture. In some aspects, the jackfruit or jackfruit derivative comprises a young jackfruit or is prepared from a young jackfruit.

In some aspects, the young jackfruit has a human digestible sugar content of any suitable amount. In some aspects, the human digestible sugar content (wt. %) of a young jackfruit is 0.001, 0.005, 0.01, 0.05, 0.1, 0.15, 0.2, 0.25, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.5, 3, 3.5, 4, 4.5, or 5, based on the total weight of the young jackfruit. Each of the foregoing numbers can be preceded by the word “about,” “at least about,” or “less than about,” and any of the foregoing numbers can be used singly to describe an open-ended range or in combination to describe a close-ended range. For example, in some aspects, the human digestible sugar content (wt. %) of a young jackfruit is less than about 0.1 wt. %, about 0.005 wt. % to about 0.25 wt. %, or about 0.001 wt. % to about 0.05 wt. %.

In some aspects, the young jackfruit has any suitable spine density. For example, the spine density (per square inch) of a suitable young jackfruit is 5, 10, 15, 20, 25, 30, 35, 40, 45, 50, 55, 60, 65, 70, 75, 80, 85, 90, 95, or 100. Each of the foregoing numbers can be preceded by the word “about,” “at least about,” or “less than about,” and any of the foregoing numbers can be used singly to describe an open-ended range or in combination to describe a close-ended range. For example, in some aspects, the spine density (per square inch) of a suitable young jackfruit is about 10 to about 80, about 5 to about 55, or less than about 75.

In some aspects, the young jackfruit has any suitable mass. For example, the mass (g) of a suitable young jackfruit is 400, 450, 500, 550, 600, 700, 800, 900, 1000, 1200, 1400, 1600, 1800, 2000, 2200, 2400, 2600, 2800, 3000, 3250, 3500, 3750, 4000, 4250, 4500, 4750, 5000, 5250, 5500, 5750, or 6000. Each of the foregoing numbers can be preceded by the word “about,” “at least about,” or “less than about,” and any of the foregoing numbers can be used singly to describe an open-ended range or in combination to describe a close-ended range. For example, in some aspects, the mass (g) of a suitable young jackfruit is about 450 to about 5500, about 3200 to about 4500, or less than about 5000.

In some aspects, the young jackfruit is harvested at any suitable age as measured from the date of flower setting on the trees (i.e., a target harvest date). For example, the age (days) of a suitable young jackfruit is 35, 36, 37, 38, 39, 40, 41, 42, 43, 44, 45, 46, 48, 50, 52, 54, 56, 58, 60, 62, 64, 66, 68, 70, 72, 74, 76, 78, 80, 81, 82, 83, 84, 85, 86, 87, 88, 89, 90, 91, 92, 93, 94, 95, 96, 97, 98, 99, or 100. Each of the foregoing numbers can be preceded by the word “about,” “at least about,” or “less than about,” and any of the foregoing numbers can be used singly to describe an open-ended range or in combination to describe a close-ended range. For example, in some aspects, the age (days) when harvested of a suitable young jackfruit is about 40 to about 90, about 38 to about 78, or less than about 90. In some aspects, there is a given period of time of about 2, 4, 6, 8, 10, 12, 14, 16, 18, 20, 22, 24, 26, 28, 30, 32, 34, 36, 38, or 40 days when jackfruit on a tree is at the right maturity for harvesting. Each of the foregoing numbers can be preceded by the word “about,” “at least about,” or “less than about,” and any of the foregoing numbers can be used singly to describe an open-ended range or in combination to describe a close-ended range. As such, a target harvest date for harvesting the jackfruit may be set at, e.g., 40 days from a flower setting on the tree (or any other number disclosed herein), and it is desirable that the jackfruit is harvested, for example, within about 10-20 days from this target harvest date, at least about 22 days from this target harvest date, or less than about 14 days from this target harvest date.

In some aspects, the young jackfruit spoils, rots, browns, or otherwise becomes unsuitable for use in the processes disclosed herein within a relatively short time period after harvest. As such, in some aspects, the young jackfruit enters the manufacturing process for producing the meat-like food product, or the composition used to prepare the meat-like food product, within 1, 2, 3, 4, 5, 6, 7, 8, 9, or 10 days of harvesting. In some aspects, the young jackfruit enters the manufacturing process within 6 days of harvesting. In some aspects, the young jackfruit enters the manufacturing process within 4 days of harvesting. In some aspects, the young jackfruit enters the manufacturing process even quicker, for example, within 6, 8, 10, 12, 14, 16, 18, 20, 22, or 24 hours of harvesting. In this regard, in some aspects the jackfruit enters the manufacturing process within 24 hours of harvesting. The time from harvesting to manufacturing can be lengthened in some aspects by, for example, cooling or freezing the young jackfruit. As used herein, a young jackfruit enters the manufacturing process at the moment it is peeled.

The harvested young jackfruit can be treated in any suitable manner.

In some aspects, the outside (e.g., with peel still on) of young jackfruit is washed. In some aspects, the washing comprises water with or without mechanical brushing. In some aspects, the washing comprises ambient temperature, cool, cold, warm, or hot water. In some aspects the washing comprises a food-grade cleaning solution, e.g., peracetic acid, to reduce the level of microorganisms on the peel.

In some aspects, jackfruit with peel on is subjected to abrasion, peeling, cutting, or other peel reduction or removal process, to form a peeled jackfruit. In some aspects, 3, 4, 5, 6, 7, 8, 9, 10, 11, 12, 13, 14, 15, 16, 17, 18, 19, or 20 mm of the peel is removed. Each of the foregoing numbers can be preceded by the word “about,” “at least about,” or “less than about,” and any of the foregoing numbers can be used singly to describe an open-ended range or in combination to describe a close-ended range. For example, in some aspects, about 6 mm to about 18 mm, at least about 5 mm, or about 7 mm to about 15 mm of the peel is removed.

In some aspects, the peeled jackfruit is used immediately in the manufacturing process. In some aspects, the peeled jackfruit is immersed in a solution or otherwise contacted (e.g., via spraying) with a solution or compound after peeling or cutting, for example, within a certain time period after peeling the rind or cutting the jackfruit, or both. In some aspects, the time period (sec) is 20, 30, 40, 50, 60, 70, 80, 90, 100, 120, 140, 160, 180, 200, 220, 240, 260, 280, 300, 350, 400, 450, or 500. Each of the foregoing numbers can be preceded by the word “about,” “at least about,” or “less than about,” and any of the foregoing numbers can be used singly to describe an open-ended range or in combination to describe a close-ended range. For example, in some aspects, the peeled jackfruit is immersed in the solution within a time period (sec) about 100 to about 180, or less than about 350 sec. In some aspects, the duration (min) of the immersion is 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 100, 110, 120, 130, 140, 150, 160, 170, 180, 190, 200, 250, 300, 350, 400, 450, or 500. Each of the foregoing numbers can be preceded by the word “about,” “at least about,” or “less than about,” and any of the foregoing numbers can be used singly to describe an open-ended range or in combination to describe a close-ended range. For example, in some aspects, the duration of the immersion is at least 10 min, about 5 min to about 30 min, at least about 18 min, 15 min to 500 min, less than about 200 min, or about 10 min to about 120 min. In some aspects, the duration of the immersion can be even longer, for example, the duration is overnight e.g., 8 to 12 hours).

Cutting or peeling jackfruit in some aspects causes the jackfruit to release a thick, sticky plant latex that makes handling of the cut or peeled jackfruit difficult. The immersion step, or step that otherwise contacts the peeled or cut jackfruit with a solution or compound, facilitates release and dispersion of the sticky plant latex, which reduces to an extent contact of the sticky plant latex with equipment and workers. In some aspects, the cutting equipment is cleaned often, e.g., daily, at least partially due to the presence of sticky plant latex on the equipment. In some aspects, after a cutting step (or after each cutting step) the cut jackfruit is immersed in a solution or otherwise contacted with a solution or compound, which in some aspects reduces or inhibits browning of the jackfruit, e.g., by inhibition of one or more enzymes in jackfruit (e.g., polyphenol oxidase) responsible for such browning. In some aspects, the solution or compound that facilitates release of sticky plant latex, or reduces browning, or both, comprises water, an acid, citric acid, ascorbic acid, sorbic acid, malic acid, phosphoric acid, kojic acid, oxalic acid, caffeic acid, chlorogenic acid, coumaric acid, gallic acid, carboxylic acid, oxaloacetic acid, lactic acid, malic acid, pyruvic acid, succinic acid, formic acid, erythorbic acid, EDTA, Swertiajaponin, maclurin, onion extract, pineapple juice, lemon juice, lime juice, nectarine extract, tomato (e.g., tomato skin), fruit juice, wine, white wine, red wine, acetic acid, vinegar, hinokitiol, polyphosphates, polycarboxylic acid, N-acetyl cysteine, L-cysteine, cysteine hydrochloride, 4-hexylresorcinol, glutathione, unripe grape (e.g., juice), porphyrin, longan, or any combination thereof. Such species typically fall into one or more classes, including antioxidants, natural compounds, competitive inhibitors, chelating agents, acidulants, or any combination thereof. In some aspects, the solution comprises water and at least one acid (e.g., citric acid). When a fruit, vegetable, or other natural product is disclosed herein, it is contemplated that any form of such natural product may be employed. For example, although pineapple juice is disclosed herein, it is specifically contemplated that any form of pineapple may be employed, including cubed, crushed, pureed, and so forth, or any combination thereof. By way of another example, onion extract is disclosed herein, but other forms of onion may be used, such as onion juice, chopped onion, and so forth, or any combination thereof. This concept is specifically contemplated to apply to any natural product disclosed herein (e.g., lemon, lime, and so on).

In some aspects, the jackfruit or peeled jackfruit is reduced in size to form a size-reduced jackfruit. In some aspects, the pieces have any suitable mass. In some aspects, the mass (g) or the average mass (g) is 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.2, 4.4, 4.6, 4.8, 5, 5.5, 6, 6.5, 7, 7.5, 8, 8.5, 9, 9.5, 10, 11, 12, 13, 14, 15, 16, 17, 18, 19, 20, 25, 30, 35, 40, 45, 50, 60, 70, 80, 90, 100, 110, 120, 130, 140, 150, 160, 170, 180, 190,192, 194, 196, 198, 200, 202, 204, 206, 208, 210, 212, 214, 216, 218, 220, 222, 224, 226, 228, 230, 235, 240, 245, or 250. Each of the foregoing numbers can be preceded by the word “about,” “at least about,” or “less than about,” and any of the foregoing numbers can be used singly to describe an open-ended range or in combination to describe a close-ended range. For example, in some aspects, the size-reduced jackfruit has a mass (g) or an average mass (g) of about 0.05 to about 5, about 0.1 to about 0.6, less than about 1, less than about 4, about 2 to about 4, less than about 3, about 1 to about 210, about 0.8 to about 100, or less than about 50. In some aspects, there is a distribution of the masses of the pieces. In some aspects, the “size-reduced jackfruit” is equivalent to the “pieces of jackfruit” or “jackfruit pieces” disclosed elsewhere herein, as will be clear from context. Without wishing to be bound by theory, in some aspects it is believed that smaller size-reduced jackfruit (e.g., a mass or an average mass of less than about 10 g or less than about 5 g or any such amounts disclosed herein) facilitates integral incorporation into the meat-like food product or composition used to prepare the meat-like food product, which in turn, in some aspects, contributes to a perception on a human scale when tasting/biting/chewing that the product as a whole has a meat-like texture. Such mass or average mass measurements can be determined as described in Example 4

In some aspects, the jackfruit or peeled jackfruit is reduced in size to form a size-reduced jackfruit. In some aspects, the pieces have any suitable length. In some aspects, the length (mm) or average length (mm) is 0.1, 0.5, 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, 30, 32, 34, 36, 38, 40, 42, 44, 46, 48, 50, 55, 60, 65, or 70. Each of the foregoing numbers can be preceded by the word “about,” “at least about,” or “less than about,” and any of the foregoing numbers can be used singly to describe an open-ended range or in combination to describe a close-ended range. For example, in some aspects, the size-reduced jackfruit has a length (mm) of 0.1 to about 40, less than about 42, about 1.5 to about 38, about 1 to about 22, about 1 to about 11, about 13 to about 39, about 25, about 20 to about 30, or less than about 26. Without wishing to be bound by theory, in some aspects it is believed that smaller size-reduced jackfruit (e.g., a length or average length of less than about 50 mm or less than about 22 mm or any such length disclosed herein) facilitates integral incorporation into the meat-like food product or composition used to prepare the meat-like food product, which in turn, in some aspects, contributes to a perception on a human scale when tasting/biting/chewing that the product as a whole has a meat-like texture. Such length or average length measurements can be determined as described in Example 4.

In some aspects, the jackfruit or peeled jackfruit is reduced in size to form a size-reduced jackfruit. In some aspects, the pieces have any suitable diameter. In some aspects, the diameter (mm) or average diameter (mm) is 0.1, 0.5, 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, or 30. Each of the foregoing numbers can be preceded by the word “about,” “at least about,” or “less than about,” and any of the foregoing numbers can be used singly to describe an open-ended range or in combination to describe a close-ended range. For example, in some aspects, the size-reduced jackfruit has a diameter (mm) of about 1 to about 15, about 2.5 to about 13, about 4 to about 5, about 3, about 0.5 to about 13, less than about 15, less than about 13, less than about 8.5, or less than about 5.5. Without wishing to be bound by theory, in some aspects it is believed that smaller size-reduced jackfruit (e.g., a diameter or average diameter of less than about 20 mm or less than about 15 mm or any such diameter disclosed herein) facilitates integral incorporation into the meat-like food product or composition used to prepare the meat-like food product, which in turn, in some aspects, contributes to a perception on a human scale when tasting/biting/chewing that the product as a whole has a meat-like texture. Such diameter or average diameter measurements can be determined as described in Example 4.

In some aspects, the pieces of jackfruit can be prepared by any suitable method. For example, the size-reduced jackfruit can be prepared by chopping, shredding, dicing, slicing, cubing, grinding, cutting, exploding, flaking, or any combination thereof. In some aspects, two or more stages of size reduction are employed. Suitable grinding processes include employing one or more grind plates, and one or more grinding steps. Such grinding plates include any standard plate employed in commercial equipment. In some aspects, size-reduced jackfruit can be prepared, for example, by grinding, cutting, or otherwise size reducing frozen jackfruit (e.g., strands thereof) or unfrozen jackfruit (e.g., strands thereof) using any suitable method, including a meat grinder, slicer, or other method that employs one or more such size reduction steps, in which the ground, sliced, cut, flaked, etc. jackfruit is passed through the same or different size reduction method.

In some aspects, the size-reduced jackfruit is subjected to a process comprising elevated temperature for a time period. In some aspects, the process comprises blanching or cooking. In some aspects, the process comprises water, steam, or a combination thereof. In some aspects, the temperature (° C.) is 60, 62, 64, 66, 68, 69, 70, 71, 72, 73, 74, 76, 78, 80, 82, 84, 86, 88, 90, 92, 94, 96, 98, 99, or 100. Each of the foregoing numbers can be preceded by the word “about,” “at least about,” or “less than about,” and any of the foregoing numbers can be used singly to describe an open-ended range or in combination to describe a close-ended range. For example, in some aspects, the temperature (° C.) is about 70 to about 99, at least about 86, or about 62 to about 90. In some aspects, the time period (min) is 0.5, 1, 1.5, 2, 2.5, 3, 3.5, 4, 4.5, 5, 5.5, 6, 6.5, 7, 7.5, 8, 8.5, 9, 9.5, 10, 11, 12, 13, 14, or 15. Each of the foregoing numbers can be preceded by the word “about,” “at least about,” or “less than about,” and any of the foregoing numbers can be used singly to describe an open-ended range or in combination to describe a close-ended range. For example, in some aspects, the time period (min) is about 1 to about 9, at least about 0.5, or less than about 12. In some aspects, the jackfruit pieces are used further in the process without additional treatment (e.g., subjecting to elevated temperature or freezing).

In some aspects, the size-reduced jackfruit that has been subjected to a process comprising elevated temperature is cooled. In some aspects, the cooling is performed immediately at the conclusion of the time period. In some aspects, the cooling is performed using a fluid. In some aspects, the fluid comprises ice, water, chilled water, or any combination thereof. In some aspects, the cooling reduces the temperature (° C.) of the pieces of jackfruit (that were subjected to an elevated temperature) to form cooled jackfruit pieces having a temperature (° C.) of 1, 2, 3, 4, 5, 6, 7, 8, 9, 10, 11, 12, 13, 14, 15, 16, 18, 20, 22, 24, 26, 28, 30, 32, 34, 35, 36, 37, 38, 39, 40, 41, 42, 43, 44, 45, 46, 47, 48, 49, or 50. Each of the foregoing numbers can be preceded by the word “about,” “at least about,” or “less than about,” and any of the foregoing numbers can be used singly to describe an open-ended range or in combination to describe a close-ended range. For example, in some aspects, the temperature (° C.) is about 12 to about 39, less than about 42, or about 2 to about 15. In some aspects, the jackfruit pieces are used further in the process without additional treatment (e.g., freezing).

In some aspects, the cooled size-reduced jackfruit, which in some aspects may have naturally increased its temperature to at or near ambient temperature, are then frozen. In some aspects, the size-reduced jackfruit that has not been subjected to an elevated temperature step, are then frozen In some aspects, the temperature (° C.) of the frozen jackfruit pieces is −50, −48, −46, −44, −42, −40, −38, −36, −34, −32, −30, −28, −26, −24, −22, −20, −18, −16, −14, −12, −10, −8, −6, −4, −2, or 0. Each of the foregoing numbers can be preceded by the word “about,” “at least about,” or “less than about,” and any of the foregoing numbers can be used singly to describe an open-ended range or in combination to describe a close-ended range. For example, in some aspects, the temperature (° C.) of the frozen jackfruit pieces is about −20 to about −12, less than about 0, or less than about −10. In some aspects, the frozen jackfruit pieces are used further in the process without additional treatment (e.g., grinding). In some aspects, the frozen jackfruit pieces are subjected to grinding prior to or during incorporation with other ingredients. In some aspects, the methods disclosed herein do not employ a freezing treatment or frozen jackfruit pieces.

In some aspects, the jackfruit contains a core. In some aspects, the core is removed at any point in a process employed to prepare the jackfruit for incorporation into a meat-like food product. For example, in some aspects, the core can be removed at any point in a process comprising one or more of washing, peeling, immersion in a solution, size reduction, cooking, cooling, freezing, or grinding of a jackfruit. In some aspects, the core is removed after peeling the jackfruit or after immersion of the jackfruit in a solution. In some aspects, the core is removed at any point prior to size reduction of the jackfruit. In some aspects, the core is removed as a consequence of size reduction, for example, by removing the jackfruit flesh away from the core such that only the core remains.

The meat-like food product, or the composition used to prepare the meat-like food product, is prepared in any suitable manner.

In some aspects, the jackfruit pieces, jackfruit pieces that have never been frozen, frozen jackfruit pieces, unfrozen jackfruit pieces, or pieces of jackfruit that were previously frozen but have since warmed to above freezing temperature, as described elsewhere herein, are subjected to further treatment prior to or during incorporation with other ingredients to form the meat-like food product, or the composition used to prepare the meat-like food product. In some aspects, the further treatment comprises grinding, cutting, or other mechanical treatment to further reduce the size of the jackfruit pieces and, e.g., facilitate incorporation into the meat-like food product or composition used to prepare the meat-like food product. In some aspects, this further treatment is performed at a temperature. In some aspects, this temperature (° C.) is −50, −48, −46, −44, −42, −40, −38, −36, −34, −32, −30, −28, −26, −24, −22, −20, −18, −16, −14, −12, −10, −8, −7, −6, −5, −4, −3, −2, −1, 0, 1, 2, 3, 4, 5, 6, 7, 8, 9, or 10. Each of the foregoing numbers can be preceded by the word “about,” “at least about,” or “less than about,” and any of the foregoing numbers can be used singly to describe an open-ended range or in combination to describe a close-ended range. For example, in some aspects, the temperature (° C.) is about −20 to about −12, about −4 to about 2, about −6 to about 1, or less than about 4.

In some aspects, there are unique challenges in harvesting and working with jackfruit. In some aspects, jackfruit experiences rapid oxidation or browning with exposure to air, particularly after peeling and/or cutting. In some aspects, the whole unpeeled jackfruit, peeled jackfruit, or cut jackfruit is blanched or cooked (e.g., with steam, hot water, or boiling water) and/or immersed in or contacted with a solution as described elsewhere herein to deactivate enzymes responsible for browning. For example, jackfruit to be used in meat-like products that are to have a white meat appearance are subjected to such a process or processes to limit or prevent browning. In some aspects, the natural browning or oxidizing process of jackfruit is controlled to achieve a desired color of the resulting jackfruit. For example, in some aspects, the jackfruit is allowed to oxidize to a limited extent (e.g., over 1, 2, 3, or 4 hours) to achieve a desirable darker color before blanching, cooking, or immersion in a solution (e.g., comprising citric acid) to stop the process. In such cases, the jackfruit is exposed to oxygen and/or temperatures at room temperature or higher to facilitate browning. The extent of such browning is tailored depending on the color of the flesh of the jackfruit, which can change depending on fruit varietal (e.g., the fruit varietals typically span the spectrum of white, to cream, to gray colored). In addition, some varietals brown or oxidize more quickly than others, such that this difference in browning or oxidizing rate is accounted for when determining the timing to achieve the desired color.

In some aspects, the jackfruit pieces prepared in the manner described elsewhere herein (whether or not frozen) are mixed in one or more steps with other ingredients described elsewhere herein. The number and ordering of steps is not particularly limited. For example, the jackfruit pieces can be mixed, at any suitable temperature, with oil, a binder, and a protein additive, as well as any other desired additional ingredients disclosed herein. For example, natural color and natural flavor ingredients may be added. In some aspects, the mixture is mixed at a temperature of about −15° C. to about 25° C., or about −10° C. to about 0° C., or about −10 C.° to about −5° C., or about −5° C. to about 10° C., or about 5° C. to about 20° C. In some aspects, this mixture is then optionally passed through an additional grinding step. The mixture (optionally ground) in some aspects is followed by extrusion, molding, sheeting, or otherwise forming into the desired shape to form a “raw” meat-like food product or composition used to prepare a meat-like food product. In some aspects, such “raw” product is complete and can be to sold to consumers as a raw product (e.g., as a burger or brick for later cooking at home, in a restaurant, and the like).

In some aspects, this “raw” product can be further subjected to cooking. In some aspects, this cooking comprises subjecting the “raw” meat-like food product or composition used to prepare a meat-like food product to one or more cooking steps comprising baking, steaming, boiling, frying, par frying, grilling, microwaving, infrared heating, convection heating, smoking, searing, or hot air heating, or any combination thereof. In some aspects, this cooked product can be sold as is, or can be subject to further treatment. For example, in some aspects, the cooked product can be ground or otherwise mechanically treated to create a crumble meat-like food product.

In some aspects, the meat-like product is produced in any suitable form. In some aspects, the meat-like food product is in the form of a single piece (e.g., a single structure) that, for example, may be rigid or semi-rigid (and a collection of single pieces may be provided to consumers in a single consumer product, such as a bag of nuggets). In some aspects, the meat-like food product comprises a structure comprising a matrix, in which the components of the matrix substantially maintain their relative location and orientation to the other components of the matrix in three-dimensional space. In some aspects, the matrix comprises a solid or semi-solid structure. In some aspects, the structure comprising a matrix is contemplated to have the consistency of, for example, a cooked or raw ground beef burger, a cooked or raw chicken nugget, or a cooked or raw sausage. In some aspects, the meat-like product is in the form of a meatball, a nugget, a hot dog, a sausage, a sausage link, a breakfast sausage link, a dinner sausage link, a patty, a sausage patty, a breakfast sausage patty, a chopped meat, a crumbled meat, crumbles, a pulled meat, a pulled muscle, a whole muscle, a flaked meat, a sliced meat, a formed meat (e.g., a chicken wing), a raw burger patty, or a raw meat, or any combination thereof, or any breaded version thereof. In some aspects, the meat-like food product is breaded (e.g., any of the forms described herein can be breaded). The meat-like food products can mimic any type of food, including chorizo, buffalo chicken wings, Italian sausage, apple sausage, al pastor, pulled pork, a burger, a hot dog, and the like.

In some aspects, the cooking and/or processing methods include oil searing, fire searing, smoking in a smoke house, batter breading, par-frying, baking, deep-frying, dry extrusion, wet extrusion, sheeting, forming with pressure/plates (as by a Formax), dehydration, or any combination thereof.

In some aspects, disclosed is a method of preparing the meat-like food product, or the composition used to prepare the meat-like food product, the method comprising: providing jackfruit pieces comprising the jackfruit or the jackfruit derivative; mixing the jackfruit pieces with a binding agent, a protein additive, and water to form a mixture; and forming, sheeting, or extruding the mixture into a desired shape; wherein the desired shape is the meat-like food product or the composition used to prepare the meat-like food product.

In some aspects, the method further comprises cooking the desired shape in one or more cooking steps comprising baking, steaming, frying, par frying, grilling, microwaving, infrared heating, convection heating, searing, or hot air heating, or any combination thereof, to form a cooked jackfruit product; wherein the cooked jackfruit product is the meat-like food product.

In some aspects, the method further comprises grinding or otherwise mechanically treating the cooked jackfruit product.

In some aspects, jackfruit has a natural texture that is firmer than animal meat's texture. As a result, in some aspect, the processing of the jackfruit, which may include cutting, grinding, size-reducing, heating, cooking, steaming, impacting, contacting with enzymes, contacting with a chemical, and so on is employed to tune the texture of the jackfruit to mimic the texture of a target meat product.

In some aspects, the processing steps to prepare the meat-like products disclosed herein from a composition used to prepare the meat-like food products include: creating meat-like shapes and appearances, forming with extrusion or sheeting +/−gravity pressure, sausage stuffers, and Formax-type equipment, or any combination thereof. In some aspects, the processing steps to prepare the meat-like products disclosed herein include: creating meat-like surface appearance and caramelization, application of heat to the surface, in combination with the inclusion of Maillard reactive proteins and caramelizing sugars in our recipes (which may be naturally present, added separately, or both), or any combination thereof. In some aspects, the processing steps include flaking (e.g., to mimic seafood), pressing (e.g., to mimic deli meats), slicing (e.g., to mimic deli meats or sliced roasts), braising or slow-cooking (e.g., mimic whole-muscle roasts and braises), use of water-knives (e.g., to produce meat-like shapes and sub-primal cuts, e.g., such as fillets, medallions, ribs, loins, rounds, steaks, chops, boneless/skinless breasts, boneless/skinless thighs, and boneless/skinless legs/drumsticks). In some aspects, any combination of processing steps can be employed.

In some aspects, various ingredients can be employed to prepare the meat-like products, or the composition used to prepare the meat-like food products. For example, in some aspects, such ingredients include ingredients that change from raw appearance to a cooked appearance, e.g., using natural colors that change from red to brown as heat is applied. In some aspects, such ingredients include creating meat-like texture by combining jackfruit with binding agents, as described elsewhere herein. In some aspects, such ingredients include a combination of jackfruit and protein additives, as described elsewhere herein. In some aspects, any combination of ingredients disclosed herein can be employed at any processing step.

In some aspects, the meat-like food product, or the composition used to prepare the meat-like food product, comprises an emulsion. In some aspects, the emulsion is an oil-in-water emulsion. In some aspects, the emulsion is a water-in-oil emulsion. In some aspects, the meat-like food product comprises aligned fibers. In some aspects, the aligned fibers comprise protein. In some aspects, the aligned fibers comprise a binding agent. In some aspects, the aligned fibers comprise fiber. In some aspects, the aligned fibers comprise jackfruit. In some aspects, the aligned fibers do not comprise jackfruit. In some aspects, the aligned fibers comprise one or more of protein, binding agent, fiber, or jackfruit, or any combination thereof. In some aspects, the meat-like food product, or the composition used to prepare the meat-like food product, does not comprise an emulsion. In some aspects, the meat-like food product, or the composition used to prepare the meat-like food product, does not comprise aligned fibers, for example, other than any aligned fibers present in jackfruit. In some aspects, the meat-like food product, or the composition used to prepare the meat-like food product, does not comprise aligned fibers comprising protein.

In some aspects, the meat-like food product, or the composition used to prepare the meat-like food product, comprises total protein in any suitable amount. In some aspects, the meat-like food product, or the composition used to prepare the meat-like food product, comprises total protein in an amount (wt. %) of 1, 2, 3, 4, 5, 6, 7, 8, 9, 10, 12, 14, 16, 18, 20, 22, 24, 25, 26, 28, 30, 32, 34, 36, 38, or 40, based on the total weight of the meat-like food product, or the composition used to prepare the meat-like food product. Each of the foregoing numbers can be preceded by the word “about,” “at least about,” or “less than about,” and any of the foregoing numbers can be used singly to describe an open-ended range or in combination to describe a close-ended range. For example, in some aspects, the meat-like food product, or the composition used to prepare the meat-like food product, comprises total protein in an amount of about 1 wt. % to about 25 wt. %, about 2 wt. % to about 15 wt. %, about 6 wt. % to about 13 wt. %, about 4 wt. % to about 12 wt. %, at least about 6 wt. %, or less than about 18 wt. %.

In some aspects, the meat-like food product, or the composition used to prepare the meat-like food product, comprises total fat in any suitable amount. In some aspects, the meat-like food product, or the composition used to prepare the meat-like food product, comprises total fat in an amount (wt. %) of 1, 2, 3, 4, 5, 6, 7, 8, 9, 10, 12, 14, 16, 18, 20, 22, 24, or 25, based on the total weight of the meat-like food product, or the composition used to prepare the meat-like food product. Each of the foregoing numbers can be preceded by the word “about,” “at least about,” or “less than about,” and any of the foregoing numbers can be used singly to describe an open-ended range or in combination to describe a close-ended range. For example, in some aspects, the meat-like food product, or the composition used to prepare the meat-like food product, comprises total fat in an amount of less than about 20 wt. %, about 1 wt. % to about 25 wt. %, about 3 wt. % to about 20 wt. %, about 6 wt. % to about 15 wt. %, about 5 wt. % to about 20 wt. %, or less than about 14 wt. %.

In some aspects, the meat-like food product, or the composition used to prepare the meat-like food product, comprises saturated fat in any suitable amount. In some aspects, the meat-like food product, or the composition used to prepare the meat-like food product, comprises saturated fat in an amount (wt. %) of 1, 2, 3, 4, 5, 6, 7, 8, 9, 10, 11, 12, 13, 14, or 15, based on the total weight of the meat-like food product, or the composition used to prepare the meat-like food product. Each of the foregoing numbers can be preceded by the word “about,” “at least about,” or “less than about,” and any of the foregoing numbers can be used singly to describe an open-ended range or in combination to describe a close-ended range. For example, in some aspects, the meat-like food product, or the composition used to prepare the meat-like food product, comprises saturated fat in an amount of less than about 9 wt. %, at least about 2 wt. %, about 1 wt. % to about 15 wt. %, about 3 wt. % to about 9 wt. %, about 6 wt. % to about 8 wt. %, less than about 14 wt. %, or less than about 7 wt. %.

In some aspects, the meat-like food product, or the composition used to prepare the meat-like food product, comprises any suitable amount of total carbohydrate. In some aspects, the total carbohydrate content is 1, 2, 3, 4, 5, 6, 7, 8, 9, 10, 11, 12, 13, 14, 15, 16, 17, 18, 19, 20, 22, 24, 25, 26, 28, or 30, based on the total weight of the meat-like food product, or the composition used to prepare the meat-like food product. Each of the foregoing numbers can be preceded by the word “about,” “at least about,” or “less than about,” and any of the foregoing numbers can be used singly to describe an open-ended range or in combination to describe a close-ended range. For example, in some aspects, the meat-like food product, or the composition used to prepare the meat-like food product, comprises total carbohydrate in an amount of less than about 25 wt. %, about 1 wt. % to about 30 wt. %, about 5 wt. % to about 28 wt. %, about 8 wt. % to about 24 wt. %, less than about 30 wt. %, or less than about 18 wt. %.

In some aspects, the meat-like food product, or the composition used to prepare the meat-like food product, comprises total fiber in any suitable amount. In some aspects, jackfruit is high in fiber, such that products made with a large proportion of jackfruit achieve a “good source” or “excellent source” of fiber claim. In some aspects, the meat-like food product, or the composition used to prepare the meat-like food product, comprises total fiber in an amount (wt. %) of 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, or 20, based on the total weight of the meat-like food product, or the composition used to prepare the meat-like food product. Each of the foregoing numbers can be preceded by the word “about,” “at least about,” or “less than about,” and any of the foregoing numbers can be used singly to describe an open-ended range or in combination to describe a close-ended range. For example, in some aspects, the meat-like food product, or the composition used to prepare the meat-like food product, comprises total fiber in an amount of about 5 wt. % to about 10 wt. %, about 5 wt. % to about 15 wt. %, about 3 wt. % to about 20 wt. %, about 1 wt. % to about 20 wt. %, at least about 3 wt. %, at least about 5 wt. %, at least about 7 wt. %, or at least about 9 wt. %. In some aspects, the meat-like food product, or the composition used to prepare the meat-like food product, comprises more fiber content than a comparable plant-based meat alternative food product. In some aspects, the “total fiber” refers to the total dietary fiber.

In some aspects, the meat-like food product, or the composition used to prepare the meat-like food product, comprises total cholesterol in any suitable amount. In some aspects, the meat-like food product, or the composition used to prepare the meat-like food product, comprises total cholesterol in an amount (wt. %) of 0.01, 0.015, 0.02, 0.025, 0.03, 0.035, 0.04, 0.045, 0.05, 0.06, 0.07, 0.08, 0.09, 0.1, 0.12, 0.14, 0.16, 0.18, 0.2, 0.22, 0.24, 0.26, 0.28, 0.3, 0.32, 0.34, 0.36, 0.38, 0.4, 0.45, 0.5, 0.55, 0.6, 0.65, 0.7, 0.75, 0.8, 0.85, 0.9, 0.95, 1, 1.1, 1.2, 1.3, 1.4, 1.5, 1.6, 1.7, 1.8, 1.9, or 2 based on the total weight of the meat-like food product, or the composition used to prepare the meat-like food product. Each of the foregoing numbers can be preceded by the word “about,” “at least about,” or “less than about,” and any of the foregoing numbers can be used singly to describe an open-ended range or in combination to describe a close-ended range. For example, in some aspects, the meat-like food product, or the composition used to prepare the meat-like food product, comprises total cholesterol in an amount of about 0 wt. %, less than about 1 wt. %, about 0.1 wt. % to about 2 wt. %, less than about 0.6 wt. %, less than about 0.4 wt. %, less than about 0.02 wt. %, about 0 wt. % to about 0.02 wt. %, about 0.025 wt. % to about 0.4 wt. %, or less than about 0.1 wt. %. In some aspects, the meat-like food product, or the composition used to prepare the meat-like food product, is substantially free of cholesterol. In some aspects, total cholesterol is low (e.g., less than about 0.02 wt. % or about 0 wt. %), at least in part due to not including any product of animal origin (e.g., animal protein such as beef, chicken, or egg (e.g., egg white and/or yolk), or animal fat such as present in milk, cheese, or yogurt) in the meat-like food product or composition used to prepare the meat-like food product. In some aspects, the total cholesterol amount is higher (e.g., at least 0.025 wt. % or at least 0.3 wt. %), for example, if product of animal origin is employed.

In some aspects, the meat-like food product, or the composition used to prepare the meat-like food product, comprises an allergen in any suitable amount. In some aspects, the meat-like food product, or the composition used to prepare the meat-like food product, comprises an allergen in an amount (wt. %) of 0.001, 0.005, 0.01, 0.05, 0.1, 0.15, 0.2, 0.25, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.5, 3, 3.5, 4, 4.5, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, based on the total weight of the meat-like food product, or the composition used to prepare the meat-like food product. Each of the foregoing numbers can be preceded by the word “about,” “at least about,” or “less than about,” and any of the foregoing numbers can be used singly to describe an open-ended range or in combination to describe a close-ended range. For example, in some aspects, the meat-like food product, or the composition used to prepare the meat-like food product, comprises an allergen in an amount of less than about 0.01 wt. %, about 1.3 wt. % to about 3 wt. %, less than about 5 wt. %, about 12 wt. % to about 20 wt. %, or about 30 wt. % to about 40 wt. %. In some aspects, the foregoing amounts of allergen can refer to an individual allergen. In some aspects, the foregoing amounts can refer to the total allergen amount (e.g., a combination of all allergens present, such as the combination of soy flour and wheat flour). In some aspects, the allergen is soy. In some embodiments, the allergen is gluten. In some aspects, the allergen is wheat. In some aspects, the allergen is a tree nut. In some aspects, the allergen is peanut. In some aspects, the allergen is milk or dairy. In some aspects, the allergen is lactose. In some aspects, the allergen is egg. In some aspects, the allergen is any combination of the allergens disclosed herein. In some aspects, the meat-like food product, or the composition used to prepare the meat-like food product, is substantially free of allergens.

In some aspects the meat-like food product, or the composition used to prepare the meat-like food product, comprises jackfruit or a jackfruit derivative in any suitable amount. For example, in some aspects, the amount (wt. %) of jackfruit is 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 62, 64, 65, 66, 68, 70, 72, 74, 75, 76, 78, 80, 82, 84, 85, 86, 88, 90, 92, 94, 95, 96, 97, 98, or 99, based on the total weight of the meat-like food product, or the composition used to prepare the meat-like food product. Each of the foregoing numbers can be preceded by the word “about,” “at least about,” or “less than about,” and any of the foregoing numbers can be used singly to describe an open-ended range or in combination to describe a close-ended range. For example, in some aspects, the meat-like food product, or the composition used to prepare the meat-like food product, comprises jackfruit or a jackfruit derivative in an amount of about 30 wt. % to about 90 wt. %, at least about 28 wt. %, about 25 wt. % to about 37 wt. %, about 25 wt. % to about 95 wt. %, at least about 25 wt. %, about 34 wt. % to about 86 wt. %, about 36 wt. % to about 43 wt. %, about 36 wt. % to about 44 wt. %, about 30 wt. % to about 55 wt. %, about 44 wt. % to about 53 wt. %, about 47 wt. % to about 53 wt. %, about 46 wt. % to about 55 wt. %, about 42 wt. % to about 65 wt. %, about 31 wt. % to about 36 wt. %, about 32 wt. % to about 37 wt. %, about 32 wt. % to about 38 wt. %, about 28 wt. % to about 44 wt. %, about 30 to about 36 wt. %, about 26 wt. % to about 42 wt. %, about 30 wt. % to about 42 wt. %, about 40 wt. % to about 50 wt. %, about 45 wt. % to about 50 wt. %, or about 34 wt. % to 50 wt. %. If both jackfruit and a jackfruit derivative is present, the sum total of jackfruit and jackfruit derivative is used in the weight percent calculation.

In some aspects, the meat-like food product, or the composition used to prepare the meat-like food product, comprises water in any suitable amount. For example, in some aspects, the amount (wt. %) of water is 1, 2, 3, 4, 5, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, based on the total weight of the meat-like food product, or the composition used to prepare the meat-like food product. Each of the foregoing numbers can be preceded by the word “about,” “at least about,” or “less than about,” and any of the foregoing numbers can be used singly to describe an open-ended range or in combination to describe a close-ended range. For example, in some aspects, the meat-like food product, or the composition used to prepare the meat-like food product, comprises water in an amount of about 1 wt. % to about 6 wt. %, about 10 wt. % to about 25 wt. %, about 10 wt. % to about 35 wt. %, less than about 34 wt. %, about 5 wt. % to about 40 wt. %, about 14 wt. % to about 24 wt. %, about 16 wt. % to about 22 wt. %, about 16 wt. % to about 26 wt. %, about 12 wt. % to about 20 wt. %, about 12 wt. % to about 26 wt. %, about 18 wt. % to about 23 wt. %, about 18 wt. % to about 24 wt. %, about 14 wt. % to about 30 wt. %, about 20 wt. % to about 30 wt. %, about 28 wt. % to about 38 wt. %, about 29 wt. % to about 38 wt. %, about 24 wt. % to about 42 wt. %, about 22 wt. % to about 26 wt. %, about 18 wt. % to about 32 wt. %, or at least about 10 wt. %. The foregoing amounts of water can be used to refer to added water (e.g., water that is additional to any water naturally present in any ingredient), or to water present in the meat-like food product or the composition used to prepare the meat-like food product regardless of source.

In some aspects, the meat-like food product, or the composition used to prepare the meat-like food product, comprises a protein additive in any suitable amount. For example, in some aspects, the amount (wt. %) of a protein additive is 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 32, 34, 36, 38, or 40, based on the total weight of the meat-like food product, or the composition used to prepare the meat-like food product. Each of the foregoing numbers can be preceded by the word “about,” “at least about,” or “less than about,” and any of the foregoing numbers can be used singly to describe an open-ended range or in combination to describe a close-ended range. For example, in some aspects, the meat-like food product, or the composition used to prepare the meat-like food product, comprises a protein additive in an amount of about 0 w.% to about 10 wt. %, about 5 wt. % to about 24 wt. %, at least about 8 wt. %, about 1 wt. % to about 25 wt. %, about 9 wt. % to about 13 wt. %, about 7 wt. % to about 15 wt. %, about 7 wt. % to about 18 wt. %, about 9 wt. % to about 22 wt. %, about 12 wt. % to about 18 wt. %, about 10 wt. % to about 15 wt. %, about 10 wt. % to about 18 wt. %, about 10 wt. % to about 20 wt. %, about 20 wt. % to about 28 wt. %, about 16 wt. % to about 32 wt. %, about 14 wt. % to about 18 wt. %, about 12 wt. % to about 16 wt. %, about 11 wt. % to about 21 wt. %, or less than about 32 wt. %. In some aspects, a protein additive is not employed in the meat-like food product, or the composition used to prepare the meat-like food product.

In some aspects, any suitable protein additive can be used in the meat-like food product, or the composition used to prepare the meat-like food product. In some aspects, the protein additive comprises soy, banana, yellow pea, green pea, mycelium, mushroom, myco-protein, fermented pea-and-rice, mung bean, chickpea, water lentil, seaweed, algae, hemp, textured vegetable protein, SUPRO MAX, a seed (e.g., sunflower, pumpkin, sesame, chia, flax, or any combination thereof, in any form, such as ground, chopped, or whole), a nut (e.g., peanut, walnut, pecan, brazil, almond, pine, cashew, or any combination thereof, in any form, such as ground, chopped, or whole), soy, soy flour, a bean (e.g., soy bean, pinto bean, kidney bean, lima bean, navy bean, broad bean, or any combination thereof, in any form, such as ground, chopped, a paste, a powder, dried, mashed, or whole), gluten, wheat gluten, rye gluten, spelt gluten, barley gluten, triticale gluten, oat, rice, brown rice, white rice, potato, pongamia, egg, egg white, egg yolk, dairy, whey, milk, cheese, yogurt, Greek yogurt, seafood, insect, insect powder, cell-based meat, jackfruit or a jackfruit derivative, or any protein powder or derivative thereof, or any combination thereof. In some aspects, the protein additive comprises a non-animal protein. In some aspects, the protein additive comprises a vegetable protein. In some aspects, the protein additive comprises a vegan protein. In some aspects, the protein additive comprises a synthetic protein. In some aspects, the protein comprises yeast or microbial biomass. In some aspects, the protein comprises an animal protein. In some aspects, the animal protein comprises beef, chicken, pork, venison, seafood, fish, or any combination thereof. In some aspects, the protein additive comprises egg. In some aspects, the protein additive comprises dairy. The protein additives disclosed herein can be employed in any combination. In some aspects, the meat-like food product or the composition used to prepare the meat-like food product does not comprise an animal product (e.g., an animal protein, animal fat, or any product of animal origin). In some aspects, the meat-like food product or the composition used to prepare the meat-like food product is recognized as vegan and/or vegetarian as such terms are generally understood by the vegan and/or vegetarian communities or certifying organizations (e.g., vegan.org).

In some aspects, the meat-like food product or the composition used to prepare the meat-like food product comprises an animal protein additive in addition to jackfruit or jackfruit derivative. Although such a food product or composition thereof includes an animal protein additive, all disclosures elsewhere herein relating to the “meat-like food product” or “composition used to prepare the meat-like food product” are still applicable (e.g., such a product is even more “meat-like”). In some aspects, such an animal protein containing product or composition does not include a binding agent, a non-animal protein additive, an oil, or any combination thereof; however, in some aspects, such an animal protein containing product or composition includes a binding agent, a non-animal protein additive, an oil, or any combination thereof if desired. In some products, products comprising a protein additive derived from animal origin (e.g., animal protein additive) provide food products that have a familiar meat texture while providing the possibility of including less animal meat than is normal in a given product (e.g., beef burger or chicken nuggets) while increasing the fiber content (e.g., due to jackfruit), both of which provide an overall healthier product than traditional meat-containing foods. Such a product can provide a “gateway food” to meat eaters reluctant to give up traditional meat.

In some aspects, the meat-like food product or the composition used to prepare the meat-like food product comprises an animal protein additive in any suitable amount relative to jackfruit. In some aspects, the food product or the composition used to prepare the meat-like food product comprises an animal protein additive in an amount (wt. %) of 5, 10, 15, 20, 25, 30, 35, 40, 45, 50, 55, 60, 65, 70, 75, 80, 85, 90, or 95, based on 100 wt. % of the total weight of animal protein additive and jackfruit or jackfruit derivative. Each of the foregoing numbers can be preceded by the word “about,” “at least about,” or “less than about,” and any of the foregoing numbers can be used singly to describe an open-ended range or in combination to describe a close-ended range. For example, in some aspects, the meat-like food product, or the composition used to prepare the meat-like food product, comprises animal protein additive in an amount (wt. %) of about 30 to about 50, less than about 60, about 20 to about 40, about 40 to about 80, or at least about 30, based on 100 wt. % of the total weight of animal protein additive and jackfruit or jackfruit derivative.

The protein additive can be employed in any suitable form, e.g., as a powder, paste, liquid, solid, flake, strand, chunk, grind, or any other form. In addition, the protein additive can be combined with jackfruit in any suitable manner, e.g., via mixing, coating, tossing, spraying, pressure infusing, or any other suitable means. In this regard, in some aspects the jackfruit is first size reduced or otherwise processed as disclosed elsewhere herein to facilitate incorporation of the protein additive with the jackfruit.

In some aspects, the protein additive contributes beneficial properties to the meat-like food product. For example, in some aspects the protein additive (e.g., textured vegetable protein) contributes protein and a bouncy texture. In some aspects, the protein additive (e.g., SUPRO MAX) contributes protein and a striated texture. Although jackfruit is naturally lower in protein, consumers typically expect a meat-like food product (e.g., meat alternative product) to be high in protein. As a result, the addition of a protein additive achieves a desirable protein level for the meat-like food product.

In some aspects, the meat-like food product, or the composition used to prepare the meat-like food product, comprises a binding agent in any suitable amount. For example, in some aspects, the amount (wt. %) of a binding agent is 0, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.2, 5.4, 5.6, 5.8, 6, 6.5, 7, 7.5, 8, 8.5, 9, 9.5, 10, 11, 12, 13, 14, 15, 16, 17, 18, 19, 20, 21, 22, 23, 24, or 25, based on the total weight of the meat-like food product, or the composition used to prepare the meat-like food product. Each of the foregoing numbers can be preceded by the word “about,” “at least about,” or “less than about,” and any of the foregoing numbers can be used singly to describe an open-ended range or in combination to describe a close-ended range. Moreover, the foregoing numbers or ranges can refer to a single binding agent, or can be used to describe the sum total of binding agents, as will be clear from context. For example, in some aspects, the meat-like food product, or the composition used to prepare the meat-like food product, comprises a binding agent in an amount of about 0.5 wt. % to about 2.5 wt. %, less than about 5 wt. %, about 0.5 wt. % to about 25 wt. %, about 18 wt. % to about 22 wt. %, about 15 wt. % to about 24 wt. %, about 10 to about 18 wt. %, about 13 wt. % to about 18 wt. %, about 3 wt. % to about 6 wt. %, about 1 wt. % to about 8 wt. %, about 2 wt. % to about 8 wt. %, about 0.5 wt. % to about 3.5 wt. %, about 0.5 wt. % to about 4 wt. %, about 0.1 wt. % to about 5 wt. %, about 4 wt. % to about 6 wt. %, about 2 wt. % to about 8 wt. %, about 1 wt. % to about 2 wt. %, about 0.6 wt. % to about 4 wt. %, or at least about 1.5 wt. %. In some aspects, a binding agent is not employed in the meat-like food product, or the composition used to prepare the meat-like food product. In some aspects, when an animal protein or product of animal origin is employed (e.g., beef, chicken, animal fat, etc.), it is typically not necessary to include a binding agent, but a binding agent may still be included if desired.

In some aspects, any suitable binding agent can be used. In some aspects, the binding agent comprises methylcellulose, gums, plant fiber, citrus fiber, jackfruit fiber, a flour (e.g., tapioca flour, cassava flour, wheat flour, corn flour, rye flour, banana flour, or any combination thereof), breadcrumbs, rice starch, or carrageenan, or any combination thereof. In some aspects, only one binding agent is employed, such as methyl cellulose or tapioca flour. In some aspects, combinations of binding agents are employed, and such suitable combinations include, for example, methyl cellulose and wheat flour, rice starch and breadcrumbs, methyl cellulose and rice starch, breadcrumbs and methyl cellulose, or wheat flour and rice starch.

In some aspects, the binding agent contributes to certain beneficial aspects of a meat-like food product. For example, the binding agent (e.g., methylcellulose) in some aspects creates a meat-like texture and/or chewiness, and in some aspects binds to water, fat, or both water and fat. In some aspects, a fiber (e.g., citrus fiber) binds an oil (e.g., coconut oil) to create a texture (e.g., “meat matrix”) similar to intramuscular fat.

In some aspects, the meat-like food product or the composition used to prepare the meat-like food product comprises oil or a combination of oils. In some aspects, the oil or combination of oils is present in the meat-like food product or composition used to prepare the meat-like food product in any suitable amount. For example, in some aspects, the amount (wt. %) of 0, 1, 2, 3, 4, 5, 6, 7, 8, 9, 10, 11, 12, 13, 14, 15, 16, 17, 18, 19, 20, 21, 22, 23, 24, or 25, based on the total weight of the meat-like food product, or the composition used to prepare the meat-like food product. Each of the foregoing numbers can be preceded by the word “about,” “at least about,” or “less than about,” and any of the foregoing numbers can be used singly to describe an open-ended range or in combination to describe a close-ended range. Moreover, the foregoing ranges can refer to a single oil, or can be used to describe the sum total of oils when a combination of oils is employed, as will be clear from context. For example, in some aspects, the meat-like food product, or the composition used to prepare the meat-like food product, comprises oil or a combination of oils in an amount of about 0 wt. % to about 19 wt. %, about 5 wt. % to about 20 wt. %, about 1 wt. % to about 20 wt. %, about 1 wt. % to about 10 wt. %, about 10 wt. % to about 15 wt. %, about 7 wt. % to about 20 wt. %, about 3 wt. % to about 8 wt. %, about 8 wt. % to about 11 wt. %, about 4.9 wt. % to about 13 wt. %, about 1 wt. % to about 7 wt. %, about 0.4 wt. % to about 9.5 wt. %, about 12 wt. % to about 16 wt. %, about 11 wt. % to about 19 wt. %, about 9 wt. % to about 13 wt. %, or about 8.5 wt. % to about 19 wt. %. In some aspects, oil is not employed in the meat-like food product or the composition used to prepare the meat-like food product. In some aspects, when an animal protein or product of animal origin is employed (e.g., beef, chicken, animal fat, etc.), it is typically not necessary to include an oil, but an oil may still be included if desired.

In some aspects, the meat-like food product or the composition used to prepare the meat-like food product comprises oil or a combination of oils. In some aspects, the oil is soybean, canola, sunflower, coconut, olive, corn, peanut, safflower, sesame, vegetable, cottonseed, grapeseed, walnut, flaxseed, avocado, palm, rapeseed, almond, cashew, pine nut, pistachio, pumpkin seed, rice bran, or any combination thereof. In some aspects, a suitable combination of oils is peanut oil and sesame oil, soybean oil and olive oil, olive oil and coconut oil, soybean oil and canola oil, coconut oil and canola oil, or soybean oil and coconut oil. Combinations of three or more oils is also contemplated, including soybean oil, canola oil, and coconut oil; peanut oil, sesame oil, and olive oil; coconut oil, canola oil, and soybean oil; olive oil, corn oil, peanut oil, and vegetable oil; and so on.

In some aspects, the meat-like food product, or the composition used to prepare the meat-like food product, comprises at least one additional ingredient. In some aspects, the at least one additional ingredient is present in the meat-like food product, or the composition used to prepare the meat-like food product, in any suitable amount. For example, in some aspects, the amount (wt. %) of the at least one additional ingredient is 0, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.2, 5.4, 5.6, 5.8, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, 30, 31, 32, 33. 34, 35, 36, 37, 38, 39, 40, 41, 42, 43, 44, 45, 46, 47, 48, 49, or 50, based on the total weight of the meat-like food product, or the composition used to prepare the meat-like food product. Each of the foregoing numbers can be preceded by the word “about,” “at least about,” or “less than about,” and any of the foregoing numbers can be used singly to describe an open-ended range or in combination to describe a close-ended range. Moreover, the foregoing ranges can refer to a single additional ingredient, or can be used to describe the sum total of additional ingredients, as will be clear from context. For example, in some aspects, the meat-like food product, or the composition used to prepare the meat-like food product, comprises at least one additional ingredient in an amount of about 1 wt. % to about 4 wt. %, about 2 wt. % to about 8 wt. %, about 2 wt. % to about 6 wt. %, about 3 wt. % to about 6 wt. %, at least about 18 wt. %, about 9 wt. % to about 13 wt. %, about 10 wt. % to about 15 wt. %, about 11 wt. % to about 21 wt. %, about 13 wt. % to about 41 wt. %, or less than about 32 wt. %. For example, in some aspects, the composition comprises vegetables and fruit in a combined amount of about 2 wt. % to about 10 wt. % or about 4 wt. % to about 19 wt. %. In some aspects, at least one additional ingredient is not employed in the meat-like food product, or the composition used to prepare the meat-like food product.

In some aspects, the meat-like food product, or the composition used to prepare the meat-like food product, comprises at least one additional ingredient. In some aspects, the at least one additional ingredient comprises a seasoning (e.g., seasoning blend), a spice, a flavor, a natural flavor, an artificial flavor, a color, a natural color, an artificial color, a plant fiber, yeast, yeast extract, a vegetable (e.g., onion, caramelized onion, garlic, tomato, bell pepper, red bell pepper, green bell pepper, yellow bell pepper, orange bell pepper, celery, squash, acorn squash, butternut squash, potato, sweet potato, or any combination thereof, in any suitable form, including paste, powder, chopped, or shredded), a vinegar or other acid (e.g., white vinegar, apple cider vinegar, balsamic vinegar, red wine vinegar, white wine vinegar, or any combination thereof), a sweetener, an artificial sweetener, a natural sweetener, sugar, palm sugar, maple sugar, maple syrup, honey, agave nectar or syrup, salt, a preservative (e.g., ascorbic acid, sodium ascorbate), an emulsifier (e.g., citrus fiber), a thickener, a texturizing agent, a juice (e.g., apple, pineapple, lime, lemon, grape, pear, cranberry, cherry, or any combination thereof), a fruit (e.g., apple, pineapple, lime, lemon, grape, pear, cranberry, cherry, or any combination thereof, in any suitable form, including paste, powder, chopped, or shredded), an antioxidant, an antimicrobial, or any combination thereof. As indicated above, in some aspects, the meat-like food product, or the composition used to prepare the meat-like food product, comprises at least one additional ingredient, such that combinations of two or more additional ingredients can be employed. Any combination of the at least one additional ingredient disclosed herein can be employed in the meat-like food product, or the composition used to prepare the meat-like food product. In some aspects, cherry is employed to preserve color.

In some aspects, the at least one additional ingredient comprises an antioxidant, an antimicrobial, or a combination thereof. In some aspects, such components are included in the meat-like food product or the composition used to prepare the meat-like food product, particularly when such items are sold refrigerated rather than frozen. However, such components may be used equally well in frozen items. Of the items, particularly those sold refrigerated (though applicable to frozen items as well), such antioxidants and/or antimicrobials are, in some aspects, included in items that are sold “raw” (e.g., without being substantially subjected to a heating or cooking step), since such cooking or heating dramatically reduces any microbial load present in or on the items. Suitable antioxidants include, in some aspects, cherry powder (e.g., acerola) (which also may provide 50-400 ppm of vitamin C), rosemary extract, or any combination thereof. Suitable antimicrobials include, in some aspects, salt or sea salt (e.g., to help inhibit the growth of microbiological bacteria, yeast, and molds), celery powder or cultured celery powder (e.g., to inhibit growth of bacteria such as Clostridium botulinum and which also provides between 50-150 ppm of sodium nitrate/nitrite), or a combination thereof. In some aspects, buffered vinegar (e.g., a powder) or vinegar may be employed as an antioxidant, an antimicrobial, or both (e.g., to inhibit growth of microbiological bacteria, yeast, and molds). Such antioxidants and/or antimicrobials can be employed in any combination and in any suitable amount (e.g., the amounts disclosed herein for the at least one additional ingredient). In some aspects, the at least one additional ingredient comprises an emulsifier, which reduces overall water and/or oil migration in the meat-like food product or the composition used to prepare the meat-like food product to slow oxidation (additional binding agent may also be employed for this same purpose). Furthermore, dehydration of the meat-like food product or the composition used to prepare the meat-like food product may be employed, in addition to or instead of an antioxidant and/or antimicrobial, to reduce microbial risks.

In some aspects, oil and/or the at least one additional ingredient contributes certain beneficial properties to a meat-like food product. For example, in some aspects, an oil (e.g., coconut oil) adds a thick coating mouthfeel that in some respects is similar to the mouthfeel achieved with animal fats. In some aspects, a preservative (e.g., ascorbic acid) functions as a shelf-life extender and/or adds vitamin C to the meat-like food product. In some aspects, the jackfruit has a flavor (e.g., acidic, sweet, fruity, bitter, astringent, etc.) that is masked or complemented by the addition of at least one additional ingredient, e.g., by using a seasoning, sweetener, flavor, or any combination thereof.

In some aspects, the meat-like food product, or the composition used to prepare the meat-like food product, comprises jackfruit or a jackfruit derivative and water. In some aspects, the meat-like food product, or the composition used to prepare the meat-like food product, can have any suitable weight ratio of jackfruit or jackfruit derivative to water. In some aspects, the weight ratio (X:1) of jackfruit or jackfruit derivative (X) to water (1) is 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, or 5, in which each foregoing number represents X. Each of the foregoing numbers can be preceded by the word “about,” “at least about,” or “less than about,” and any of the foregoing numbers can be used singly to describe an open-ended range or in combination to describe a close-ended range. For example, in some aspects, the meat-like food product, or the composition used to prepare the meat-like food product, has a weight ratio (X:1) of jackfruit or jackfruit derivative to water of about 1:1 to about 4:1, about 1.2:1 to about 3:1, about 2:1 to about 3:1, about 2.2:1 to about 3.4:1, or less than about 4.5:1. If both jackfruit and a jackfruit derivative is present, the sum total of jackfruit and jackfruit derivative is used in the ratio calculation.

In some aspects, the meat-like food product, or the composition used to prepare the meat-like food product, comprises jackfruit or a jackfruit derivative and a protein additive. In some aspects, the meat-like food product, or the composition used to prepare the meat-like food product, can have any suitable weight ratio of jackfruit or jackfruit derivative to the protein additive. In some aspects, the weight ratio (X:1) of jackfruit or jackfruit derivative (X) to the protein additive (1) is 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, or 6, in which each foregoing number represents X. Each of the foregoing numbers can be preceded by the word “about,” “at least about,” or “less than about,” and any of the foregoing numbers can be used singly to describe an open-ended range or in combination to describe a close-ended range. For example, in some aspects, the meat-like food product, or the composition used to prepare the meat-like food product, has a weight ratio (X:1) of jackfruit or jackfruit derivative to the protein additive of about 1.8:1 to about 4.7:1, about 3.5:1 to about 4:1, about 1.8:1 to about 3:1, about 2:1 to about 5:1, less than about 5:1, at least about 1.5:1, about 1.3:1 to about 5.1:1, about 2:1 to about 4:1, or less than about 5.5:1. If both jackfruit and a jackfruit derivative is present, the sum total of jackfruit and jackfruit derivative is used in the ratio calculation. In addition, such ratios can refer to jackfruit or jackfruit derivative relative to a single protein additive, or to a combination of two or more, or all, protein additives present in the meat-like food product or the composition used to prepare the meat-like food product.

In some aspects, the meat-like food product, or the composition used to prepare the meat-like food product, comprises water and a protein additive. In some aspects, the meat-like food product, or the composition used to prepare the meat-like food product, can have any suitable weight ratio (X:1) of water (X) to the protein additive (1). In some aspects, the weight ratio (X:1) of water (X) to the protein additive (1) is 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, or 4, in which each foregoing number represents X. Each of the foregoing numbers can be preceded by the word “about,” “at least about,” or “less than about,” and any of the foregoing numbers can be used singly to describe an open-ended range or in combination to describe a close-ended range. For example, in some aspects, the meat-like food product, or the composition used to prepare the meat-like food product, has a weight ratio (X:1) of water to the protein additive of about 1:1 to about 1.8:1, about 1:1 to about 1.6:1, at least about 1:1, at least about 1.4:1, less than about 2:1, about 0.7:1 to about 2.1:1, less than about 2.8:1, or about 1:1 to about 2:1. Such ratios can refer to a single protein additive relative to water, or to a combination of two or more, or all, protein additives relative to water.

In some aspects, the meat-like food product, or the composition used to prepare the meat-like food product, comprises jackfruit or a jackfruit derivative and oil. In some aspects, the meat-like food product, or the composition used to prepare the meat-like food product, can have any suitable weight ratio (X:1) of jackfruit (X) to oil (1). In some aspects, the weight ratio (X:1) of jackfruit (X) to oil (1) is 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, or 10, in which each foregoing number represents X. Each of the foregoing numbers can be preceded by the word “about,” “at least about,” or “less than about,” and any of the foregoing numbers can be used singly to describe an open-ended range or in combination to describe a close-ended range. For example, in some aspects, the meat-like food product, or the composition used to prepare the meat-like food product, has a weight ratio (X:1) of jackfruit or jackfruit derivative to oil of about 0.6:1 to about 3.1:1, about 2.5:1 to about 4.8:1, about 4:1 to about 5:1, about 2.6:1 to about 6.8:1, less than about 7.5:1, at least about 1.9:1, about 4:1 to about 7:1, about 2:1 to about 7.5:1, or less than about 8.5:1. If both jackfruit and a jackfruit derivative is present, the sum total of jackfruit and jackfruit derivative is used in the ratio calculation. In addition, such ratios can refer to jackfruit or jackfruit derivative relative to a single oil, or to a combination of two or more, or all, oils present in the meat-like food product or the composition used to prepare the meat-like food product.

In some aspects, the meat-like food product, or the composition used to prepare the meat-like food product, comprises jackfruit or a jackfruit derivative and a binding agent. In some aspects, the meat-like food product, or the composition used to prepare the meat-like food product, can have any suitable weight ratio (X:1) of jackfruit or jackfruit derivative to the binding agent (1). In some aspects, the weight ratio (X:1) of jackfruit or jackfruit derivative (X) to the binding agent (1) is 2, 2.2, 2.4, 2.6, 2.8, 3, 3.1, 3.2, 3.3, 3.4, 3.5, 3.6, 3.7, 3.8, 3.9, 4, 4.2, 4.4, 4.6, 4.8, 5, 5.5 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, in which each foregoing number represents X. Each of the foregoing numbers can be preceded by the word “about,” “at least about,” or “less than about,” and any of the foregoing numbers can be used singly to describe an open-ended range or in combination to describe a close-ended range. For example, in some aspects, the meat-like food product, or the composition used to prepare the meat-like food product, has a weight ratio (X:1) of jackfruit or jackfruit derivative to the binding agent of at least about 3:1, about 3.3:1 to about 40:1, about 3:1 to about 10:1, about 3:1 to about 15:1, about 5:1 to about 35:1, about 20:1 to about 33:1, about 20:1 to about 27:1, at least about 20:1, less than about 40:1, about 25:1 to about 35:1, about 15:1 to about 40:1, less than about 34:1, or at least about 10:1. If both jackfruit and a jackfruit derivative is present, the sum total of jackfruit and jackfruit derivative is used in the ratio calculation. In addition, such ratios can refer to jackfruit or jackfruit derivative relative to a single binding agent, or to a combination of two or more, or all, binding agents present in the meat-like food product or the composition used to prepare the meat-like food product.

In some aspects, the meat-like food product, or the composition used to prepare the meat-like food product, comprises jackfruit or a jackfruit derivative, a binding agent, a protein additive (of non-animal origin or animal origin), and water, as described elsewhere herein. In some aspects, such meat-like food product, or the composition used to prepare the meat-like food product, further comprises at least one additional ingredient, as described elsewhere herein. In some aspects, the at least one additional ingredient comprises yeast. In some aspects, the at least one additional ingredient comprises a fruit, a vegetable, and spices. In some aspects, the at least one additional ingredient comprises spices, flavoring (e.g., natural flavor), and coloring. In some aspects, the at least one additional ingredient comprises an acid.

In some aspects, the meat-like food product, or the composition used to prepare the meat-like food product, has any suitable pH, for example, for food safety, such as to prevent or reduce microbial growth or activity, and/or to increase shelf life. In some aspects, the pH is 2, 2.2, 2.4, 2.5, 2.6, 2.8, 3, 3.2, 3.4, 3.5, 3.6, 3.8, 4, 4.2, 4.4, 4.5, 4.6, 4.8, 5, 5.2, 5.4, 5.5, 5.6, 5.8, 6, 6.1, 6.2, 6.4, 6.5, 6.6, 6.8, 7, 7.2, 7.4, 7.5, 7.6, 7.8, 8, 8.2, 8.4, or 8.5. Each of the foregoing numbers can be preceded by the word “about,” “at least about,” or “less than about,” and any of the foregoing numbers can be used singly to describe an open-ended range or in combination to describe a close-ended range. For example, in some aspects, the pH is less than about 5, less than about 5.4, about 3 to about 6.1, about 4 to about 6, about 3.8 to about 5.6, about 5 to about 6.2, less than about 7.4, less than about 7.5, or less than about 6.5. In some aspects, the pH of the meat-like food product, or the composition used to prepare the meat-like food product, is of a suitable value as a consequence of the pH of the jackfruit employed to make the meat-like food product or the composition used to prepare the meat-like food product. In some aspects, the pH is artificially lowered by the addition of one or more acids, or raised if desired by the addition of one or more bases. Additionally, suitable buffers may be employed to control pH if desired.

Various aspects are contemplated herein, several of which are set forth in the paragraphs below. It is explicitly contemplated that any aspect or portion thereof can be combined to form an aspect.

Aspect 1: A meat-like food product, or a composition used to prepare the meat-like food product, comprising:
jackfruit or a jackfruit derivative in an amount of at least about 10 wt. %.

Aspect 2: The meat-like food product, or the composition used to prepare the meat-like food product, of any preceding aspect, wherein the jackfruit or jackfruit derivative is present in an amount of about 25 wt. % to about 95 wt. %.

Aspect 3: The meat-like food product, or the composition used to prepare the meat-like food product, of any preceding aspect, further comprising:
water in an amount of about 5 wt. % to about 40 wt. %, optionally wherein the jackfruit or jackfruit derivative is present in an amount higher than the amount of water, based on the total weight of the meat-like food product or the total weight of the composition used to prepare the meat-like food product.

Aspect 4: The meat-like food product, or the composition used to prepare the meat-like food product, of any preceding aspect, further comprising:
a protein additive in an amount of about 1 wt. % to about 25 wt. %, optionally wherein the jackfruit or jackfruit derivative is present in an amount higher than the amount of protein additive, based on the total weight of the meat-like food product or the total weight of the composition used to prepare the meat-like food product.

Aspect 5: The meat-like food product, or the composition used to prepare the meat-like food product, of aspect 4, or any preceding aspect, wherein the protein additive comprises soy, banana, yellow pea, green pea, mycelium, mushroom, myco-protein, fermented pea-and-rice, mung bean, chickpea, water lentil, seaweed, algae, hemp, wheat gluten, oat, rice, brown rice, potato, pongamia, egg, egg white, dairy, whey, seafood, insect, insect powder, cell-based meat, jackfruit, vegetable protein, textured vegetable protein, a seed, a nut, soy flour, yeast, animal protein, or microbial biomass, or any combination thereof.

Aspect 6: The meat-like food product, or the composition used to prepare the meat-like food product, of aspect 4 or aspect 5, or any preceding aspect, wherein the protein additive is from a non-animal source.

Aspect 7: The meat-like food product, or the composition used to prepare the meat-like food product, of aspect 4 or aspect 5, or any preceding aspect, wherein the protein additive is from an animal source.

Aspect 8: The meat-like food product, or the composition used to prepare the meat-like food product, of aspect 7, or any preceding aspect, wherein the composition optionally does not contain one or more of a non-animal protein additive, a binding agent, or an oil.

Aspect 9: The meat-like food product, or the composition used to prepare the meat-like food product, of any preceding aspect, further comprising:
a binding agent in an amount of about 0.5 wt. % to about 25 wt. %.

Aspect 10: The meat-like food product, or the composition used to prepare the meat-like food product, of aspect 9, or any preceding aspect, wherein the binding agent comprises methylcellulose, gums, plant fiber, citrus fiber, jackfruit fiber, a flour, tapioca flour, cassava flour, wheat flour, corn flour, rye flour, banana flour, breadcrumbs, rice starch, or carrageenan, or any combination thereof.

Aspect 11: The meat-like food product, or the composition used to prepare the meat-like food product, of any preceding aspect, further comprising:
at least one additional ingredient comprising a natural flavor, a natural color, yeast, yeast extract, a seasoning, a seasoning blend, or a vegetable, or any combination thereof.

Aspect 12: The meat-like food product, or the composition used to prepare the meat-like food product, of any preceding aspect, further comprising water:
wherein a weight ratio of the jackfruit or jackfruit derivative to the water is about 0.9:1 to about 3.8:1.

Aspect 13: The meat-like food product, or the composition used to prepare the meat-like food product, of any preceding aspect, further comprising a protein additive:
wherein a weight ratio of the jackfruit or jackfruit derivative to the protein additive is about 1.2:1 to about 5.6:1.

Aspect 14: The meat-like food product, or the composition used to prepare the meat-like food product, of any preceding aspect, further comprising a protein additive and water:
wherein a weight ratio of the water to the protein additive is about 0.4:1 to about 2.8:1.

Aspect 15: The meat-like food product, or the composition used to prepare the meat-like food product, of any preceding aspect, further comprising a binding agent:
wherein a weight ratio of the jackfruit or jackfruit derivative to the binding agent is about 2:1 to about 44:1.

Aspect 16: The meat-like food product, or the composition used to prepare the meat-like food product, of any preceding aspect, further comprising oil:
wherein a weight ratio of the jackfruit or jackfruit derivative to the oil is about 2:1 to about 10:1.

Aspect 17: The meat-like food product, or the composition used to prepare the meat-like food product, of any preceding aspect, comprising total protein in an amount of about 1 wt. % to about 25 wt. %.

Aspect 18: The meat-like food product, or the composition used to prepare the meat-like food product, of any preceding aspect, comprising total carbohydrate in an amount of about 1 wt. % to about 30 wt. %.

Aspect 19: The meat-like food product, or the composition used to prepare the meat-like food product, of any preceding aspect, comprising total fat in an amount of about 1 wt. % to about 25 wt. %.

Aspect 20: The meat-like food product, or the composition used to prepare the meat-like food product, of any preceding aspect, comprising saturated fat in an amount of about 1 wt. % to about 15 wt. %.

Aspect 21: The meat-like food product, or the composition used to prepare the meat-like food product, of any preceding aspect, comprising dietary fiber in an amount of about 1 wt. % to about 20 wt. %.

Aspect 22: The meat-like food product, or the composition used to prepare the meat-like food product, of any preceding aspect, comprising total cholesterol in an amount of less than about 1 wt. %.

Aspect 23: The meat-like food product, or the composition used to prepare the meat-like food product, of any preceding aspect, wherein the meat-like food product has a meat-like texture.

Aspect 24: The meat-like food product, or the composition used to prepare the meat-like food product, of any preceding aspect, wherein the jackfruit or jackfruit derivative comprises a young jackfruit or is prepared from a young jackfruit.

Aspect 25: The meat-like food product, or the composition used to prepare the meat-like food product, of any preceding aspect, wherein the jackfruit or jackfruit derivative comprises human digestible sugar content in an amount of less than about 0.5 wt. %.

Aspect 26: The meat-like food product of any preceding aspect, wherein the meat-like food product is in a form comprising a meatball, a nugget, a sausage link, a breakfast sausage link, a dinner sausage link, a sausage patty, a breakfast sausage patty, a chopped meat, a crumbled meat, a pulled meat, a pulled muscle, a whole muscle, a flaked meat, a formed meat, a raw burger patty, or a raw meat, or any combination thereof, or any breaded version thereof.

Aspect 27: The meat-like food product, or the composition used to prepare the meat-like food product, of any preceding aspect, further comprising oil in an amount of about 1 wt. % to about 20 wt. %.

Aspect 28: The meat-like food product, or the composition used to prepare the meat-like food product, of any preceding aspect, comprising a protein additive and a binding agent.

Aspect 29: The meat-like food product, or the composition used to prepare the meat-like food product, of any preceding aspect, comprising a protein additive, a binding agent, water, and at least 5 wt. % dietary fiber, based on total weight of the meat-like food product or the composition used to prepare the meat-like food product.

Aspect 30: The meat-like food product, or the composition used to prepare the meat-like food product, of any preceding aspect, comprising at least two, at least three, at least four, or all five of:
jackfruit or a jackfruit derivative in an amount of at least about 25 wt. %,
water in an amount of about 5 wt. % to about 40 wt. %,
a protein additive in an amount of about 1 wt. % to about 25 wt. %,
a binding agent in an amount of about 0.5 wt. % to about 25 wt. %, or
oil in an amount of about 1 wt. % to about 20 wt. %.

Aspect 31: The meat-like food product, or the composition used to prepare the meat-like food product, of any preceding aspect, comprising one or more of a protein additive, a binding agent, oil, and water, wherein at least two, at least three, at least four, or all five of the following conditions are satisfied:
a weight ratio of the jackfruit or jackfruit derivative to the water is about 0.9:1 to about 3.8:1,
a weight ratio of the jackfruit or jackfruit derivative to the protein additive is about 1.2:1 to about 5.6:1,
a weight ratio of the water to the protein additive is about 0.4:1 to about 2.8:1,
a weight ratio of the jackfruit or jackfruit derivative to the binding agent is about 2:1 to about 44:1,
a weight ratio of the jackfruit or jackfruit derivative to the oil is about 2:1 to about 10:1.

Aspect 32: The meat-like food product, or the composition used to prepare the meat-like food product, of any preceding aspect, comprising one or more of a protein additive, a binding agent, and water, wherein:
a weight ratio of the jackfruit or jackfruit derivative to the protein additive is about 1.2:1 to about 5.6:1, and
a weight ratio of the jackfruit or jackfruit derivative to the binding agent is about 2:1 to about 44:1.

Aspect 33: The meat-like food product, or the composition used to prepare the meat-like food product, of any preceding aspect, comprising at least two, at least three, at least four, or all five of:
total protein in an amount of about 1 wt. % to about 25 wt. %,
total carbohydrate in an amount of about 1 wt. % to about 30 wt. %,
total fat in an amount of about 1 wt. % to about 25 wt. %,
saturated fat in an amount of about 1 wt. % to about 15 wt. %,
dietary fiber in an amount of about 1 wt. % to about 20 wt. %.

Aspect 34: The meat-like food product, or the composition used to prepare the meat-like food product, of any preceding aspect, wherein the jackfruit or jackfruit derivative is integrally incorporated therein.

Aspect 35: The meat-like food product, or the composition used to prepare the meat-like food product, of any preceding aspect, wherein the jackfruit or jackfruit derivative comprises naturally aligned fibers.

Aspect 36: The meat-like food product, or the composition used to prepare the meat-like food product, of any preceding aspect, wherein the meat-like food product, or the composition used to prepare the meat-like food product, comprises a structure comprising a matrix, wherein components of the matrix substantially maintain their relative location and orientation to other components of the matrix in three-dimensional space.

Aspect 37: The meat-like food product, or the composition used to prepare the meat-like food product, of any preceding aspect, wherein the jackfruit or jackfruit derivative comprises size-reduced jackfruit having one or more of, including two of, or all three of:
a mass of about 0.1 g to about 10 g,
a length of about 1 mm to about 70 mm,
a diameter of about 1 mm to about 30 mm.

Aspect 38: A method of preparing the meat-like food product, or the composition used to prepare the meat-like food product, of any preceding aspect, the method comprising:
providing jackfruit pieces comprising the jackfruit or the jackfruit derivative,
mixing the jackfruit pieces with a binding agent, a protein additive, and water to form a mixture, and
forming, sheeting, or extruding the mixture into a desired shape,
wherein the desired shape is the meat-like food product or the composition used to prepare the meat-like food product.

Aspect 39: The method of aspect 38, further comprising:
cooking the desired shape in one or more cooking steps comprising baking, steaming, frying, par frying, grilling, microwaving, infrared heating, convection heating, searing, or hot air heating, or any combination thereof, to form a cooked jackfruit product,
wherein the cooked jackfruit product is the meat-like food product.

Aspect 40: The method of aspect 38 or aspect 38, further comprising:
grinding or otherwise mechanically treating the cooked jackfruit product.

### EXAMPLES

The invention can be further understood by the following non-limiting examples.

Example 1: This example illustrates the versatility of the meat-like food product, or the compositions used to prepare the meat-like food product. Table 1 sets forth exemplary amounts of components for several meat-like food products or compositions used to prepare the meat-like food products. All values are given in weight percent, based on the total weight of the meat-like food product, or the compositions used to prepare the meat-like food product. Any range in any cell can be combined with any other range in the same column to provide a composition. In addition, any amount disclosed elsewhere herein for each component in Table 1 (e.g., jackfruit, binding agent, etc.) can be substituted in the relevant cell in Table 1 to provide a composition.

TABLE 1

| | Meatball | Raw Burger | Crumble | Sausage |
|---|---|---|---|---|
| Jackfruit | 36-43 | 44-53 | 32-37 | 31-36 |
| | 25-37 | | 45-50 | 40-50 |
| | | | | 30-42 |
| Water^{†} | 14-24 | 16-26 | 29-38 | 22-26 |
| | 12-20 | | 1-6 | 10-25 |
| | | | | 20-30 |
| Protein Additive (e.g., | 7-18 | 10-18 | 20-28 | 14-18 |
| non-animal protein such | 9-22 | | 0-10 | 12-16 |
| as soy, or animal protein^{‡} | | | | 10-15 |
| such as chicken) | | | | |
| Oil | 10-15 | 8-11 | 1-7 | 12-16 |
| | | | 0-19 | 11-19 |
| | | | | 9-13 |
| Binding Agent | ****2-8 | **0.5-4 | ***4-6 | **1-2 |
| | | | *****13-18 | |
| *Additional Ingredients | 1-4 | 3-6 | 1-4 | 10-15 |
| | 2-6 | | 13-41 | 11-21 |
| | | | | 9-13 |

*Sum of additional ingredients, e.g., flavoring, coloring, spices, and the like
**e.g., methylcellulose
***e.g., rice starch and/or methylcellulose
****e.g., breadcrumbs and/or methylcellulose
*****e.g., a starch, a flour, or a combination thereof
^{†}amount of added water (does not include water present from jackfruit or other sources)
^{‡}when an animal protein additive is employed, a binding agent, oil, and non-animal protein additive typically are not employed, and the remaining components in the table are proportioned accordingly; however, such components may be employed if desired.

Example 2: This example illustrates the nutritional content of the meat-like food products, or the compositions used to prepare the meat-like food product, of Example 1. Table 2 sets forth the nutritional content. All values are in weight percent, based on the total weight of the meat-like food product, or the compositions used to prepare the meat-like food product. The amounts in Table 2 are generally applicable when non-animal protein additive(s) and/or component(s) not from animal origin is/are employed. When animal protein(s) and/or component(s) of animal origin is/are employed, certain values in Table 2 typically will be different (e.g., higher total fat, higher saturated fat, higher cholesterol, lower dietary fiber, and so forth).

TABLE 2

| | Meatball | Raw Burger | Crumble | Sausage |
|---|---|---|---|---|
| Total Fat | 10-14 | 11-15 | 4-6 | 13-16 |
| Saturated Fat | 6-9 | 4-6 | 2-4 | 8-10 |
| Total | 15-19 | 10-13 | 13-16 | 14-16 |
| Carbohydrates | | | | |
| Dietary Fiber | 8-11 | 7-9 | 10-12 | 8-11 |
| Total Protein | 9-12 | 8-12 | 10-14 | 10-12 |
| Cholesterol | 0 | 0 | 0 | 0 |

Example 3: This example demonstrates, in one aspect, some characteristics of a young jackfruit that is suitable for use in processes and meat-like food products disclosed herein.

TABLE 3
General:

| | |
|---|---|
| Description | The meat-like portion of a jackfruit at its meat-like stage of |
| | maturation. Harvested, prepared, and frozen for use in |
| | plant-based or blended meat products. |
| Appearance | White to off-white in color. Chunks up to 1″ in size, with |
| | smaller loose pieces and shreds. |
| Organoleptic | Neutral, mildly acidic flavor and firm texture. |
| Storage and Handling | Store frozen, closed, at about −18° C. in a clean, dry, well- |
| | ventilated warehouse, away from odorous materials. |
| Shelf-life | 24 months from date of manufacture with proper storage. |
| Allergens | None |
| Non-GMO | This product is not genetically modified or genetically |
| | engineered |

TABLE 4
Microbiological Data:

| | Upper Limit | |
|---|---|---|
| Coliforms | <2,000 | cfu/g |
| TVC | <100,000 | cfu/g |
| Yeast and Mold | <1,000 | cfu/g |

| | |
|---|---|
| E. coli O157:H7 | Negative |
| Listeria monocytogenes | Negative |
| Salmonella spp. | Negative |

TABLE 5
Nutritional Data (per 100 grams):

| | | | | | |
|---|---|---|---|---|---|
| Energy | 36.84 | Kcal | Vitamin A | <38 | mcg |
| Fat | <0.1 | g | Vitamin C | <2 | mg |
| Saturated Fat | <0.1 | g | Vitamin E | 0.31 | mg |
| Cholesterol | <1.0 | mg | Calcium | 40.23 | mg |
| Protein | 1.3 | g | Copper | 0.18 | mg |
| Total Carbohydrates | 7.82 | g | Iron | 0.47 | mg |
| Total Dietary Fiber | 6.27 | g | Magnesium | 26.53 | mg |
| Soluble Fiber Sugars | 1.93 | g | Manganese | 0.46 | mg |
| Insoluble Fiber | 4.34 | g | Potassium | 127.0 | mg |
| Total Sugar | <0.5 | g | Sodium | 2.21 | mg |
| Moisture | 90.39 | g | Zinc | 0.21 | mg |

| | | |
|---|---|---|
| Ash | 0.46 | g |

Example 4: This example demonstrates, in one aspect, some characteristics of size-reduced jackfruit, such as mass, length, and diameter, that is suitable for use in processes, meat-like food products, and/or compositions used to prepare the meat-like food products disclosed herein.

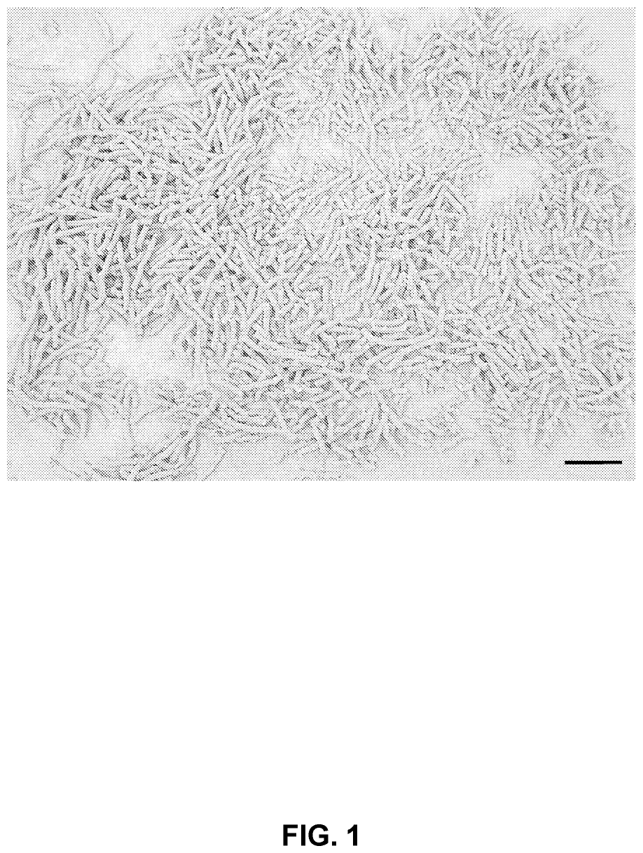

Frozen jackfruit was size-reduced using seven different methods, as shown below in Table 6. The max numbers are from size-reducing jackfruit (e.g., strands up to 2 feet long, though shorter strands or other forms of jackfruit can be employed if desired). All “n/a” entries indicate the size was too small to measure. Length and diameter measurements were performed using a caliper that reads in both inches and mm. Mass measurements were performed using a balance that can read to 000.00 g. Average length, diameter, and mass were determined by measuring 10-25 samples and averaging the result based on a number average. The results are shown in FIGS. 1-3.

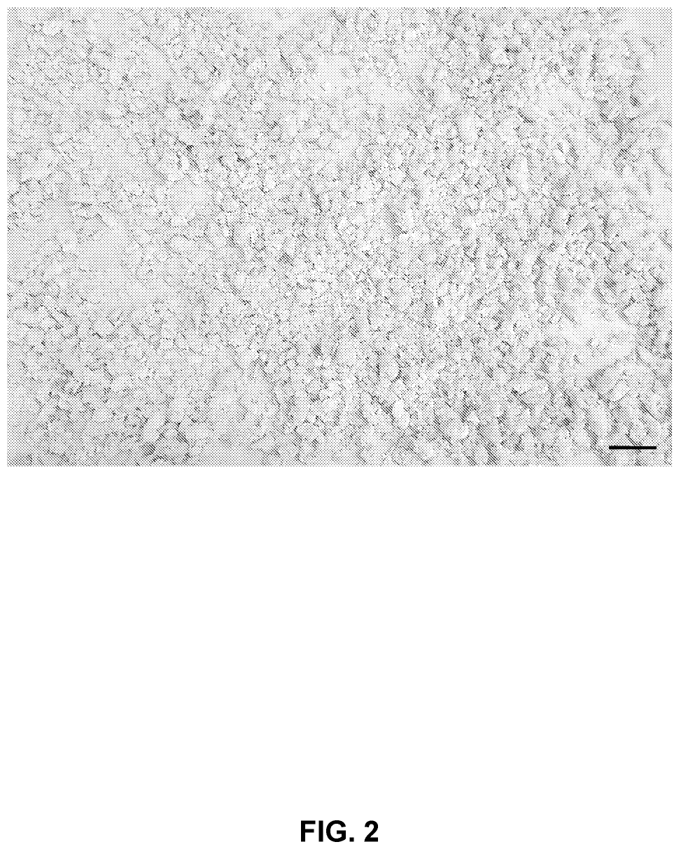

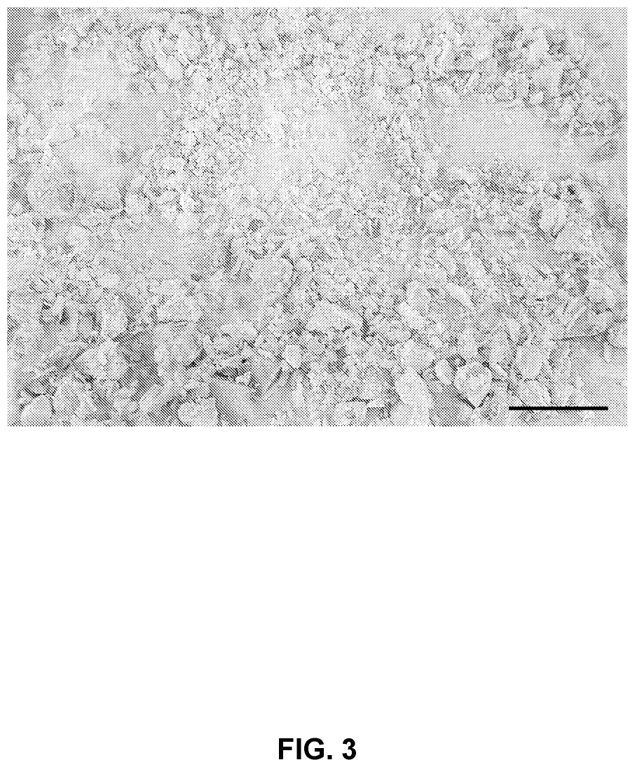

TABLE 6
Size-Reduced Jackfruit Sizes

| Size Reduction | Mass (g) | | Length (mm) | | Diameter (mm) | |
|---|---|---|---|---|---|---|
| Method* | Min | Max | Min | Max | Min | Max |
| 1 | n/a | 3.05 | n/a | 21 | n/a | 12 |
| (FIG. 3) | | | | | | |
| 2 | n/a | 0.34 | n/a | 8 | n/a | 12 |
| 3 | n/a | 0.56 | n/a | 19 | n/a | 8 |
| (FIG. 2) | | | | | | |
| 4 | n/a | 0.13 | n/a | 10 | n/a | 6 |
| 5 | n/a | 0.41 | 2 | 31 | 4 | 5 |
| 6 | n/a | 0.24 | 5 | 36 | 3 | 3 |
| (FIG. 1) | | | | | | |
| 7 | 0.9 | 5.1 | 13.5 | 38.5 | 17 | 19 |

| | | |
|---|---|---|
| average: 2.90 | average: 25.5 | — |

*Any suitable size reduction method disclosed elsewhere herein can be employed to achieve the values listed in this table, including cutting, abrading, grinding, chopping, and the like, or any combination thereof.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

Every device, system, formulation, combination of components, or method described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

We claim:

1. A meat-like food product, or a composition used to prepare the meat-like food product, comprising:
jackfruit or a jackfruit derivative in an amount of at least about 10 wt. %.

2. The meat-like food product, or the composition used to prepare the meat-like food product, of claim 1, wherein the jackfruit or jackfruit derivative is present in an amount of about 25 wt. % to about 95 wt. %.

3. The meat-like food product, or the composition used to prepare the meat-like food product, of any preceding claim, further comprising:
water in an amount of about 5 wt. % to about 40 wt. %, optionally wherein the jackfruit or jackfruit derivative is present in an amount higher than the amount of water, based on the total weight of the meat-like food product or the total weight of the composition used to prepare the meat-like food product.

4. The meat-like food product, or the composition used to prepare the meat-like food product, of any preceding claim, further comprising:
a protein additive in an amount of about 1 wt. % to about 25 wt. %, optionally wherein the jackfruit or jackfruit derivative is present in an amount higher than the amount of protein additive, based on the total weight of the meat-like food product or the total weight of the composition used to prepare the meat-like food product.

5. The meat-like food product, or the composition used to prepare the meat-like food product, of claim 4, wherein the protein additive comprises soy, banana, yellow pea, green pea, mycelium, mushroom, myco-protein, fermented pea-and-rice, mung bean, chickpea, water lentil, seaweed, algae, hemp, wheat gluten, oat, rice, brown rice, potato, pongamia, egg, egg white, dairy, whey, seafood, insect, insect powder, cell-based meat, jackfruit, vegetable protein, textured vegetable protein, a seed, a nut, soy flour, yeast, animal protein, or microbial biomass, or any combination thereof.

6. The meat-like food product, or the composition used to prepare the meat-like food product, of claim 4 or claim 5, wherein the protein additive is from a non-animal source.

7. The meat-like food product, or the composition used to prepare the meat-like food product, of claim 4 or claim 5, wherein the protein additive is from an animal source.

8. The meat-like food product, or the composition used to prepare the meat-like food product, of claim 7, wherein the composition optionally does not contain one or more of a non-animal protein additive, a binding agent, or an oil.

9. The meat-like food product, or the composition used to prepare the meat-like food product, of any preceding claim, further comprising:
a binding agent in an amount of about 0.5 wt. % to about 25 wt. %.

10. The meat-like food product, or the composition used to prepare the meat-like food product, of claim 9, wherein the binding agent comprises methylcellulose, gums, plant fiber, citrus fiber, jackfruit fiber, a flour, tapioca flour, cassava flour, wheat flour, corn flour, rye flour, banana flour, breadcrumbs, rice starch, or carrageenan, or any combination thereof.

11. The meat-like food product, or the composition used to prepare the meat-like food product, of any preceding claim, further comprising:
at least one additional ingredient comprising a natural flavor, a natural color, yeast, yeast extract, a seasoning, a seasoning blend, or a vegetable, or any combination thereof.

12. The meat-like food product, or the composition used to prepare the meat-like food product, of any preceding claim, further comprising water:
wherein a weight ratio of the jackfruit or jackfruit derivative to the water is about 0.9:1 to about 3.8:1.

13. The meat-like food product, or the composition used to prepare the meat-like food product, of any preceding claim, further comprising a protein additive:
wherein a weight ratio of the jackfruit or jackfruit derivative to the protein additive is about 1.2:1 to about 5.6:1.

14. The meat-like food product, or the composition used to prepare the meat-like food product, of any preceding claim, further comprising a protein additive and water:
wherein a weight ratio of the water to the protein additive is about 0.4:1 to about 2.8:1.

15. The meat-like food product, or the composition used to prepare the meat-like food product, of any preceding claim, further comprising a binding agent:
wherein a weight ratio of the jackfruit or jackfruit derivative to the binding agent is about 2:1 to about 44:1.

16. The meat-like food product, or the composition used to prepare the meat-like food product, of any preceding claim, further comprising oil:
wherein a weight ratio of the jackfruit or jackfruit derivative to the oil is about 2:1 to about 10:1.

17. The meat-like food product, or the composition used to prepare the meat-like food product, of any preceding claim, comprising total protein in an amount of about 1 wt. % to about 25 wt. %.

18. The meat-like food product, or the composition used to prepare the meat-like food product, of any preceding claim, comprising total carbohydrate in an amount of about 1 wt. % to about 30 wt. %.

19. The meat-like food product, or the composition used to prepare the meat-like food product, of any preceding claim, comprising total fat in an amount of about 1 wt. % to about 25 wt. %.

20. The meat-like food product, or the composition used to prepare the meat-like food product, of any preceding claim, comprising saturated fat in an amount of about 1 wt. % to about 15 wt. %.

21. The meat-like food product, or the composition used to prepare the meat-like food product, of any preceding claim, comprising dietary fiber in an amount of about 1 wt. % to about 20 wt. %.

22. The meat-like food product, or the composition used to prepare the meat-like food product, of any preceding claim, comprising total cholesterol in an amount of less than about 1 wt. %.

23. The meat-like food product, or the composition used to prepare the meat-like food product, of any preceding claim, wherein the meat-like food product has a meat-like texture.

24. The meat-like food product, or the composition used to prepare the meat-like food product, of any preceding claim, wherein the jackfruit or jackfruit derivative comprises a young jackfruit or is prepared from a young jackfruit.

25. The meat-like food product, or the composition used to prepare the meat-like food product, of any preceding claim, wherein the jackfruit or jackfruit derivative comprises human digestible sugar content in an amount of less than about 0.5 wt. %.

26. The meat-like food product of any preceding claim, wherein the meat-like food product is in a form comprising a meatball, a nugget, a sausage link, a breakfast sausage link, a dinner sausage link, a sausage patty, a breakfast sausage patty, a chopped meat, a crumbled meat, a pulled meat, a pulled muscle, a whole muscle, a flaked meat, a formed meat, a raw burger patty, or a raw meat, or any combination thereof, or any breaded version thereof.

27. The meat-like food product, or the composition used to prepare the meat-like food product, of any preceding claim, further comprising oil in an amount of about 1 wt. % to about 20 wt. %.

28. The meat-like food product, or the composition used to prepare the meat-like food product, of any preceding claim, comprising a protein additive and a binding agent.

29. The meat-like food product, or the composition used to prepare the meat-like food product, of any preceding claim, comprising a protein additive, a binding agent, water, and at least 5 wt. % dietary fiber, based on total weight of the meat-like food product or the composition used to prepare the meat-like food product.

30. The meat-like food product, or the composition used to prepare the meat-like food product, of any preceding claim, comprising at least two of:
a. jackfruit or a jackfruit derivative in an amount of at least about 25 wt. %,
b. water in an amount of about 5 wt. % to about 40 wt. %,
c. a protein additive in an amount of about 1 wt. % to about 25 wt. %,
d. a binding agent in an amount of about 0.5 wt. % to about 25 wt. %, or
e. oil in an amount of about 1 wt. % to about 20 wt. %.

31. The meat-like food product, or the composition used to prepare the meat-like food product, of any preceding claim, comprising at least three of:
a. jackfruit or a jackfruit derivative in an amount of at least about 25 wt. %,
b. water in an amount of about 5 wt. % to about 40 wt. %,
c. a protein additive in an amount of about 1 wt. % to about 25 wt. %,
d. a binding agent in an amount of about 0.5 wt. % to about 25 wt. %, or
e. oil in an amount of about 1 wt. % to about 20 wt. %.

32. The meat-like food product, or the composition used to prepare the meat-like food product, of any preceding claim, comprising at least four of:
a. jackfruit or a jackfruit derivative in an amount of at least about 25 wt. %,
b. water in an amount of about 5 wt. % to about 40 wt. %,
c. a protein additive in an amount of about 1 wt. % to about 25 wt. %,
d. a binding agent in an amount of about 0.5 wt. % to about 25 wt. %, or
e. oil in an amount of about 1 wt. % to about 20 wt. %.

33. The meat-like food product, or the composition used to prepare the meat-like food product, of any preceding claim, comprising:
a. jackfruit or a jackfruit derivative in an amount of at least about 25 wt. %,
b. water in an amount of about 5 wt. % to about 40 wt. %,
c. a protein additive in an amount of about 1 wt. % to about 25 wt. %,
d. a binding agent in an amount of about 0.5 wt. % to about 25 wt. %, and
e. oil in an amount of about 1 wt. % to about 20 wt. %.

34. The meat-like food product, or the composition used to prepare the meat-like food product, of any preceding claim, comprising one or more of a protein additive, a binding agent, oil, and water, wherein at least two of the following conditions are satisfied:
a. a weight ratio of the jackfruit or jackfruit derivative to the water is about 0.9:1 to about 3.8:1,
b. a weight ratio of the jackfruit or jackfruit derivative to the protein additive is about 1.2:1 to about 5.6:1,
c. a weight ratio of the water to the protein additive is about 0.4:1 to about 2.8:1,
d. a weight ratio of the jackfruit or jackfruit derivative to the binding agent is about 2:1 to about 44:1,
e. a weight ratio of the jackfruit or jackfruit derivative to the oil is about 2:1 to about 10:1.

35. The meat-like food product, or the composition used to prepare the meat-like food product, of any preceding claim, comprising one or more of a protein additive, a binding agent, oil, and water, wherein at least three of the following conditions are satisfied:
a. a weight ratio of the jackfruit or jackfruit derivative to the water is about 0.9:1 to about 3.8:1,
b. a weight ratio of the jackfruit or jackfruit derivative to the protein additive is about 1.2:1 to about 5.6:1,
c. a weight ratio of the water to the protein additive is about 0.4:1 to about 2.8:1,
d. a weight ratio of the jackfruit or jackfruit derivative to the binding agent is about 2:1 to about 44:1,
e. a weight ratio of the jackfruit or jackfruit derivative to the oil is about 2:1 to about 10:1.

36. The meat-like food product, or the composition used to prepare the meat-like food product, of any preceding claim, comprising one or more of a protein additive, a binding agent, oil, and water, wherein:
a. a weight ratio of the jackfruit or jackfruit derivative to the water is about 0.9:1 to about 3.8:1,
b. a weight ratio of the jackfruit or jackfruit derivative to the protein additive is about 1.2:1 to about 5.6:1,
c. a weight ratio of the water to the protein additive is about 0.4:1 to about 2.8:1, and
d. a weight ratio of the jackfruit or jackfruit derivative to the binding agent is about 2:1 to about 44:1,
e. a weight ratio of the jackfruit or jackfruit derivative to the oil is about 2:1 to about 10:1.

37. The meat-like food product, or the composition used to prepare the meat-like food product, of any preceding claim, comprising one or more of a protein additive, a binding agent, and water, wherein:
a. a weight ratio of the jackfruit or jackfruit derivative to the protein additive is about 1.2:1 to about 5.6:1, and
b. a weight ratio of the jackfruit or jackfruit derivative to the binding agent is about 2:1 to about 44:1.

38. The meat-like food product, or the composition used to prepare the meat-like food product, of any preceding claim, comprising at least two of:
a. total protein in an amount of about 1 wt. % to about 25 wt. %,
b. total carbohydrate in an amount of about 1 wt. % to about 30 wt. %,
c. total fat in an amount of about 1 wt. % to about 25 wt. %,
d. saturated fat in an amount of about 1 wt. % to about 15 wt. %,
e. dietary fiber in an amount of about 1 wt. % to about 20 wt. %.

39. The meat-like food product, or the composition used to prepare the meat-like food product, of any preceding claim, comprising at least three of:
a. total protein in an amount of about 1 wt. % to about 25 wt. %,
b. total carbohydrate in an amount of about 1 wt. % to about 30 wt. %,
c. total fat in an amount of about 1 wt. % to about 25 wt. %,
d. saturated fat in an amount of about 1 wt. % to about 15 wt. %,
e. dietary fiber in an amount of about 1 wt. % to about 20 wt. %.

40. The meat-like food product, or the composition used to prepare the meat-like food product, of any preceding claim, comprising at least four of:
a. total protein in an amount of about 1 wt. % to about 25 wt. %,
b. total carbohydrate in an amount of about 1 wt. % to about 30 wt. %,
c. total fat in an amount of about 1 wt. % to about 25 wt. %,
d. saturated fat in an amount of about 1 wt. % to about 15 wt. %,
e. dietary fiber in an amount of about 1 wt. % to about 20 wt. %.

41. The meat-like food product, or the composition used to prepare the meat-like food product, of any preceding claim, comprising:
a. total protein in an amount of about 1 wt. % to about 25 wt. %,
b. total carbohydrate in an amount of about 1 wt. % to about 30 wt. %,
c. total fat in an amount of about 1 wt. % to about 25 wt. %,
d. saturated fat in an amount of about 1 wt. % to about 15 wt. %, and
e. dietary fiber in an amount of about 1 wt. % to about 20 wt. %.

42. The meat-like food product, or the composition used to prepare the meat-like food product, of any preceding claim, wherein the jackfruit or jackfruit derivative is integrally incorporated therein.

43. The meat-like food product, or the composition used to prepare the meat-like food product, of any preceding claim, wherein the jackfruit or jackfruit derivative comprises naturally aligned fibers.

44. The meat-like food product, or the composition used to prepare the meat-like food product, of any preceding claim, wherein the meat-like food product, or the composition used to prepare the meat-like food product, comprises a structure comprising a matrix, wherein components of the matrix substantially maintain their relative location and orientation to other components of the matrix in three-dimensional space.

45. The meat-like food product, or the composition used to prepare the meat-like food product, of any preceding claim, wherein the jackfruit or jackfruit derivative comprises size-reduced jackfruit having one or more of:
a. a mass of about 0.1 g to about 10 g,
b. a length of about 1 mm to about 70 mm,
c. a diameter of about 1 mm to about 30 mm.

46. A method of preparing the meat-like food product, or the composition used to prepare the meat-like food product, of any preceding claim, the method comprising:
providing jackfruit pieces comprising the jackfruit or the jackfruit derivative,
mixing the jackfruit pieces with a binding agent, a protein additive, and water to form a mixture, and
forming, sheeting, or extruding the mixture into a desired shape,
wherein the desired shape is the meat-like food product or the composition used to prepare the meat-like food product.

47. The method of claim 46, further comprising:
cooking the desired shape in one or more cooking steps comprising baking, steaming, frying, par frying, grilling, microwaving, infrared heating, convection heating, searing, or hot air heating, or any combination thereof, to form a cooked jackfruit product,
wherein the cooked jackfruit product is the meat-like food product.

48. The method of claim 46 or claim 47, further comprising:
grinding or otherwise mechanically treating the cooked jackfruit product.
